(19) United States
(12) Patent Application Publication
(10) Pub. No.: US 2026/0350587 A1
(43) Pub. Date: Nov. 5, 2026

(54) System And Method For Asset Authentication And Transfer Using Blockchain Technology

(71) Applicant: Carta, L.L.C., St. Louis, MO (US)

(72) Inventor: Jonathan Giallanzo, St. Louis, MO (US)

(21) Appl. No.: 19/468,705

(22) Filed: Feb. 3, 2026

Related U.S. Application Data
(63) Continuation-in-part of application No. PCT/US2024/040735, filed on Aug. 2, 2024.
(60) Provisional application No. 63/530,947, filed on Aug. 4, 2023.

(51) Int. Cl. G06Q 20/36; G06Q 20/32; G06Q 20/38

(52) U.S. Cl. CPC G06Q 20/3672; G06Q 20/3278; G06Q 20/3674; G06Q 20/389

(57) ABSTRACT

A computerized method for non-fungible token authentication includes creating an asset non-fungible token (NFT) associated with a physical asset, storing, in a partner wallet, a link between the asset NFT and a tag attached to the physical asset, wherein the tag includes at least one of a radio-frequency identification (RFID) tag or a near-field communication tag, initiating a transfer of the asset NFT to a user, receiving confirmation of wireless communication between a mobile computing device of the user and the tag attached to the physical asset, and transferring the asset NFT into a user wallet in response to confirmation of wireless communication between a mobile computing device of the user and the tag attached to the physical asset.

### CROSS-REFERENCE TO RELATED APPLICATIONS

This application is a continuation-in-part of PCT Patent Application No. PCT/US 2024/040735 filed Aug. 2, 2024 (published as WO 2025/034559 on Feb. 13, 2025), which claimed priority to and the benefit of U.S. Provisional Patent Application No. 63/530,947 filed Aug. 4, 2023. The entire contents of the above applications are incorporated herein by reference.

### FIELD

This disclosure relates to a system and method for asset authentication using blockchain technology, and in particular for accurately verifying a collectible item's authenticity and provenance during an online item transaction and facilitating transfer of a collectible item. In some example embodiments, a tag such as RFID or NFC may be on a physical item, where the tag is tied to creation of an asset token and is used in the authentication process.

### BACKGROUND

This section provides background information related to the present disclosure which is not necessarily prior art.

Rare collectibles and alike assets, such as rare books, artworks, and limited-edition products are often traded and sold in various marketplaces. For example, an artwork might be sold at auction or listed on a user-to-user online sales platform (e.g., eBay); a rare book might be offered for sale on various websites; and limited-edition products (e.g., sneakers and footwear) might be listed on re-sale websites or sold by individuals utilizing social media platforms.

Authenticating and valuing these particular assets can be nearly impossible if an accurate and detailed record of the chain of title, sales history, and origination information is not maintained and transferred with the asset during subsequent ownership changes. As a result, many valuable collectible assets have imperfect and incomplete provenance information and are inaccurately valued in the rare collectible marketplace.

Further, this incomplete provenance information and lack of accurate data leaves open the opportunity for scammers to market fake and illegitimate items to prospective purchasers. Many purchasers are aware of the threat of scammers and are reluctant to transfer funds in an online manner without first having the item authenticated. In many circumstances there is not a method of secure authentication, and the purchaser walks away from the transaction. Alternatively, if the purchaser does in fact complete the transaction, they may consequently fall victim to the scammer and be left the new owner of a fake collectible item.

Many other issues exist that do not stem from deceitful motives of scammers, such as the incorrect valuation of collectible items and items lost in the marketplace. An undervalued item fails to capture the efficient market price and can leave a seller with less-than-optimal trade gain. An overvalued item can be troublesome for the current owner, particularly if the owner purchased the item at an inflated price and now suffers a loss to sell the item at its actual market value. An accurate count of how many of a rare item currently exists can be impossible to determine when an item disappears for decades until it finally resurfaces again when offered for sale. In some example embodiments, systems and method described herein may mitigate fraudulent items in the marketplace, by facilitating blacklisting of fraudulent items or making items as possibly fraudulent or stolen.

Various applications have attempted to solve this problem, such as large online item transaction platforms offering an in-house authentication service when elected by the purchaser. However, these authentication services can be time consuming and do not occur until after the purchaser has tendered payment to the seller. Instead of authenticating the item in real-time before the transactions completes, these services act as insurance for the purchaser if the item does, in fact, turn out to be inauthentic. Additionally, current applications fail to provide a third-party registry and only base authentication on information collected from the current owner. The history of the item is unaccounted for when determining authenticity.

### SUMMARY

This section provides a general summary of the disclosure and is not a comprehensive disclosure of its full scope or all of its features.

An example computerized method for non-fungible token authentication includes creating an asset non-fungible token (NFT) associated with a physical asset, storing, in a partner wallet, a link between the asset NFT and a tag attached to the physical asset, wherein the tag includes at least one of a radio-frequency identification (RFID) tag or a near-field communication tag, initiating a transfer of the asset NFT to a user, receiving confirmation of wireless communication between a mobile computing device of the user and the tag attached to the physical asset, and transferring the asset NFT into a user wallet in response to confirmation of wireless communication between a mobile computing device of the user and the tag attached to the physical asset.

In some examples, the asset NFT includes a built-in smart contract. In some examples, the built-in smart contract includes a transfer fee.

In some examples, the method includes, subsequent to initiating the transfer of the asset NFT to the user, storing the asset NFT in a transfer queue on at least one server, until receiving confirmation of wireless communication between the mobile computing device of the user and the tag attached to the physical asset.

In some examples, the partner wallet and the user wallet are each blockchain wallets configured to store multiple non-fungible tokens.

In some examples, the tag attached to the physical asset is an RFID tag, and receiving confirmation of wireless communication between the mobile computing device of the user and the RFID tag includes an RFID signal detection of the RFID tag by the mobile computing device.

In some examples, the tag attached to the physical asset is an NFC tag, and receiving confirmation of wireless communication between the mobile computing device of the user and the NFC tag includes an NFC signal detection of the NFC tag by the mobile computing device.

In some examples, the mobile computing device is a smartphone or tablet. In some examples, blockchain information of the asset NFT is configured to store at least one of a title of the physical asset, a sales history of the physical asset, a chain of ownership of the physical asset, a provenance of the physical asset, or origination information of the physical asset, or authentication information of the physical asset.

In some examples, the method includes listing the asset NFT in a digital marketplace to offer the physical asset for sale or for trade.

An example system for non-fungible token authentication includes at least one physical asset, a tag attached to the physical asset, wherein the tag includes at least one of a radio-frequency identification (RFID) tag or a near-field communication tag, memory configured to store computer-executable instructions, and at least one processor configured to execute the computer-executable instructions to create an asset non-fungible token (NFT) associated with a physical asset store, in a first user wallet, a link between the asset NFT and a tag attached to the physical asset, wherein the tag includes at least one of a radio-frequency identification (RFID) tag or a near-field communication tag, initiate a transfer of the physical asset to a second user, receive confirmation of wireless communication between a mobile computing device of the second user and the tag attached to the physical asset, and transfer the asset NFT into a wallet of the second user in response to confirmation of wireless communication between a mobile computing device of the second user and the tag attached to the physical asset.

In some examples, the asset NFT includes a built-in smart contract. In some examples, the built-in smart contract includes a transfer fee.

In some examples, the at least one processor is configured to execute the computer-executable instructions to, subsequent to initiating the transfer of the asset NFT to the second user, storing the asset NFT in a transfer queue on at least one server, until receiving confirmation of wireless communication between the mobile computing device of the second user and the tag attached to the physical asset.

In some examples, the first user wallet and the second user wallet are each blockchain wallets configured to store multiple non-fungible tokens.

In some examples, the tag attached to the physical asset is an RFID tag, and receiving confirmation of wireless communication between the mobile computing device of the second user and the RFID tag includes an RFID signal detection of the RFID tag by the mobile computing device.

In some examples, the tag attached to the physical asset is an NFC tag, and receiving confirmation of wireless communication between the mobile computing device of the second user and the NFC tag includes an NFC signal detection of the NFC tag by the mobile computing device.

In some examples, the mobile computing device is a smartphone or tablet. In some examples, blockchain information of the asset NFT is configured to store at least one of a title of the physical asset, a sales history of the physical asset, a chain of ownership of the physical asset, a provenance of the physical asset, or origination information of the physical asset, or authentication information of the physical asset.

In some examples, the at least one processor is configured to execute the computer-executable instructions to store or list the asset NFT in a digital marketplace to offer the physical asset for sale or trade.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected example embodiments and not all possible implementations, and are not intended to limit the scope of the present disclosure.

FIG. 1 is a block diagram of an example digital platform operated on a user's mobile device.

FIG. 2A is a block diagram of an example graphical user interface of the digital platform for viewing, selling, and tracking provenance of collectible assets.

FIG. 2B is an illustration of an example graphical user interface of the digital platform for viewing, selling, and tracking provenance of collectible assets.

FIG. 3A is a block diagram of an example graphical user interface of the digital platform for messaging.

FIG. 3B is an illustration of an example graphical user interfaces of the digital platform for messaging.

FIG. 4A is a block diagram of an example graphical user interface of the digital platform for viewing asset details.

FIGS. 4B and 4C are illustrations of example graphical user interfaces of the digital platform for viewing asset details, including RFID information associated with the asset.

FIG. 5A is a block diagram of an example graphical user interface of the digital platform for trading assets.

FIGS. 5B-5D are illustrations of example graphical user interfaces of the digital platform for trading assets.

FIG. 6A is a block diagram of an example graphical user interface of the digital platform for asset creation and authentication.

FIG. 6B-6I are illustrations of example graphical user interfaces of the digital platform for asset creation and authentication.

FIG. 7 is a block diagram of an example graphical user interface of the digital platform for asset review and confirmation.

FIG. 8A is a drawing of an example graphical user interface of the digital platform for viewing, selling, and tracking provenance of collectible assets.

FIG. 8B is a photographical view of an example graphical user interface of the digital platform for viewing an asset marketplace.

FIG. 9 is an illustration of database(s) for storing example properties and values used in computing a Carta value for collectible assets.

FIG. 10 is a block diagram of an example system context of the mobile application interacting with the blockchain.

FIG. 11 is a flowchart illustrating an example process of confirming the digital transaction and transferring the physical asset.

FIGS. 12A and 12B are illustrations of an example embodiment of the digital platform for viewing, selling, and tracking provenance of collectible assets.

FIGS. 13A and 13B are illustrations of an example embodiment of the digital platform for viewing, selling, and tracking provenance of collectible assets.

FIGS. 14A and 14B illustrate a flowchart depicting an example method for processing a secure transaction comprising transferring funds in connection with an asset sale, updating asset information on a blockchain, and facilitating physical asset transfer post-transaction.

FIG. 15 illustrates an example architecture for an asset tracking system.

FIG. 16 illustrates an example workflow for a partner to create an asset NFT token and send to a partner customer.

FIG. 17 illustrates an example workflow for a user to transfer an asset to another user.

Corresponding reference numerals indicate corresponding parts throughout the several views of the drawings.

### DETAILED DESCRIPTION

Some example embodiments will now be described more fully with reference to the accompanying drawings.

Some example embodiments of a digital platform leverage blockchain technology to facilitate the viewing, selling, and tracking of physical collectible assets. The platform may utilize a user interface device, such as a smartphone or similar device, to operate an application comprising an authentication method and a searchable marketplace for listing collectible assets. Each asset listed in digital form may be assigned a Non-Fungible Token (NFT) that corresponds directly to the physical collectible asset. A tamper proof RFID/NFC tag attached to the physical asset provides a method for linking the physical asset to its assigned NFT on the blockchain. The blockchain technology facilitates or ensures accurate and immutable maintenance of the collectible asset's chain of title, sales history, and origination information during an authentication process.

An example method of creating a physical to digital asset comprising a Non-Fungible Token, authentication information, and a computed market value is also provided. This method comprises a third-party authentication method to verify the ownership and authenticity of physical collectible assets.

An example method of facilitating a secure transaction comprising transferring funds in connection with asset sale, updating asset information on the blockchain, and providing method of physical asset transfer post-transaction is also provided.

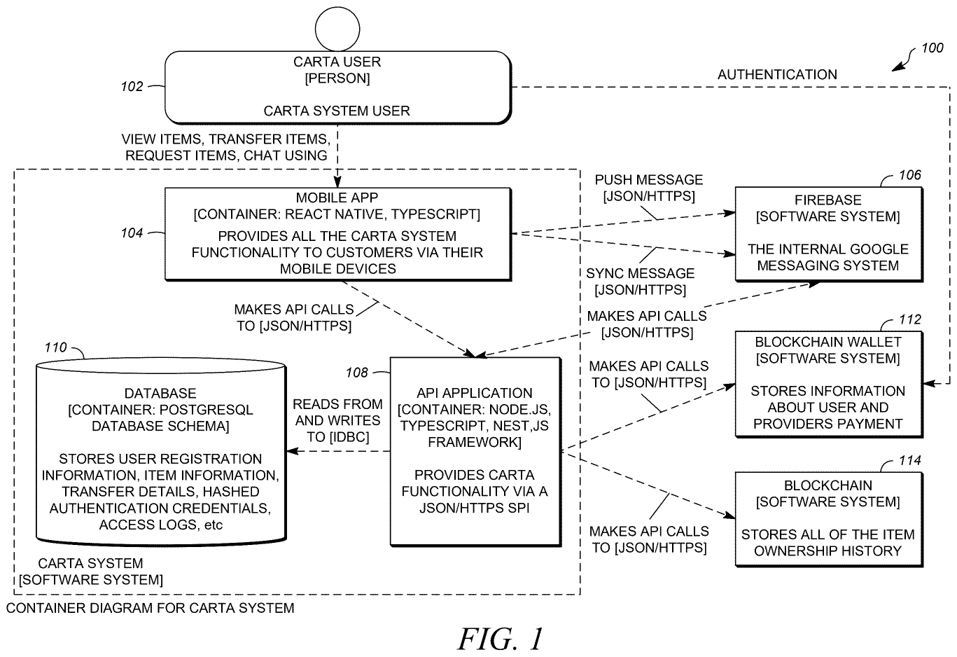

An example embodiment of a system 100 for a digital platform using blockchain technology to facilitate a system of viewing, selling, and tracking provenance of physical collectible assets is indicated generally in FIG. 1. In this example embodiment, the system 100 may be operated on a user interface device, such as a smartphone or similar device, to operate an application comprising an authentication method and a searchable marketplace for listing rare collectible assets. Each asset listed in digital form is assigned a Non-Fungible Token (NFT) that corresponds directly to the physical collectible asset. While this example embodiment is shown and described in terms of a mobile platform to be used in connection with facilitating sales of collectible physical assets, the inventive concepts are not so limited, and can be applied to facilitating transactions between users for any digital or physical item of value.

As shown in FIG. 1, the system 100 may allow a user 102 to operate a mobile application 104. The mobile application 104 may provide messages to a firebase 106, and make calls application programming interface (API) calls to an API application 108. The API application 108 may read from and write to a database 110. The API application 108 may be configured to make API calls to a blockchain wallet 112, and store information on a blockchain 114.

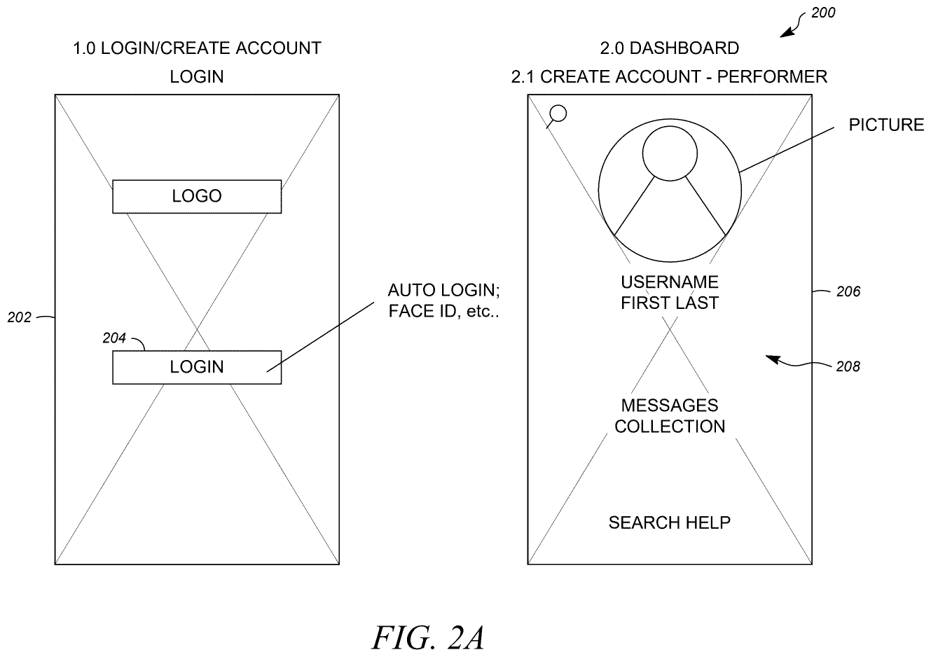

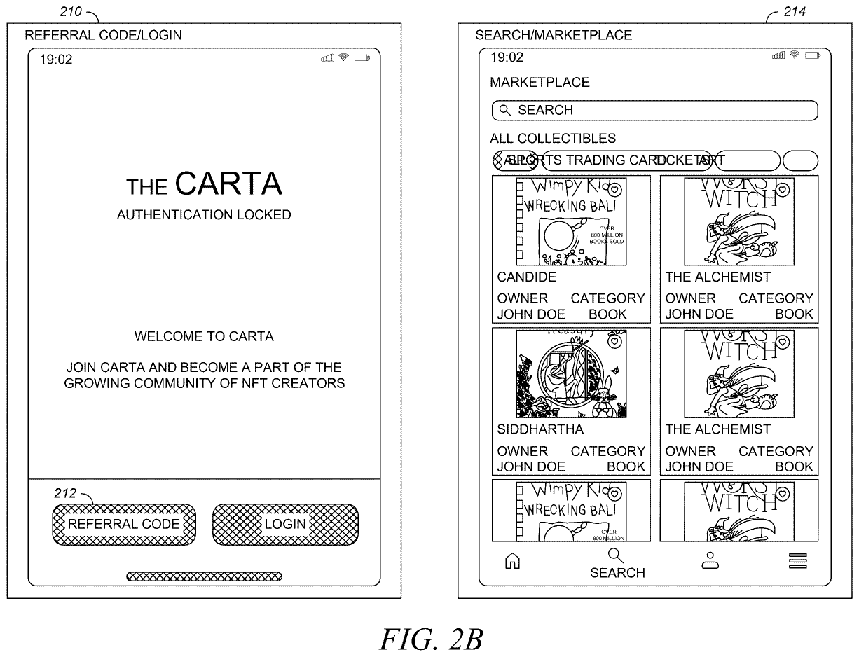

The digital platform may include a mobile application 200 for use on a user device as generally illustrated in FIGS. 2A and 2B. The mobile application 200 operates through a user interface device, such as a smartphone or similar device, equipped with an application to access the digital platform's features and functionalities. Further details below describe example implementations of the mobile application 200.

The mobile application 200 comprises user profiles and user accounts used for identifying users in transactions. FIG. 2A illustrates an example login page 202 of the mobile application 200 to collect user credentials to access a registered user account. User login 204 can be completed by entering an appropriate username and password combination, or alternatively using Face ID for auto login. If a user does not have an account, FIG. 2A generally shows an account creation page 206, where a user's picture, username, first name, and last name are input to create a user account, which may be displayed on a user interface screen 208. An example

As shown in FIG. 2B, a login page 210 may allow for use of a referral code 212. A user dashboard 214 shows a quick reference page for navigation to a user's messages, collection, search bar, and help tool.

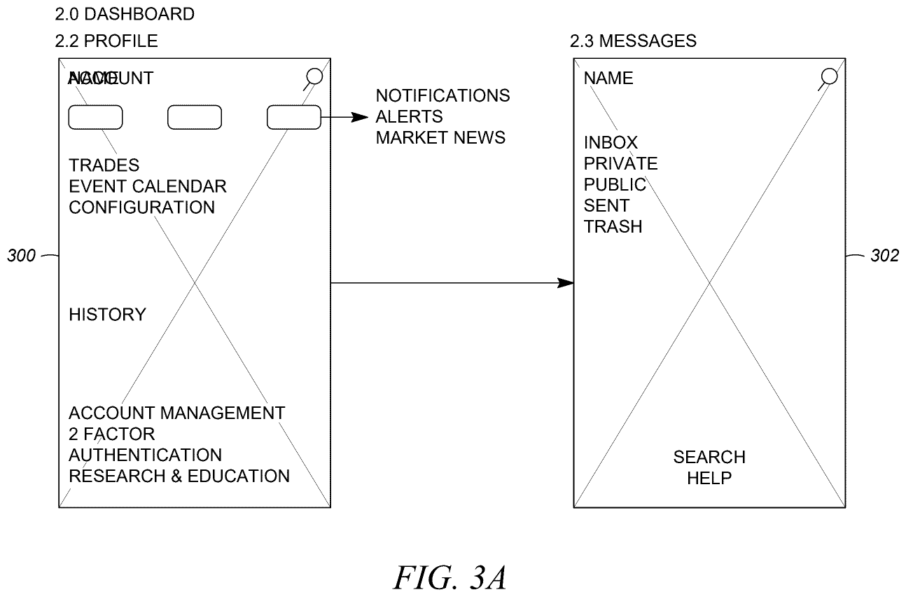

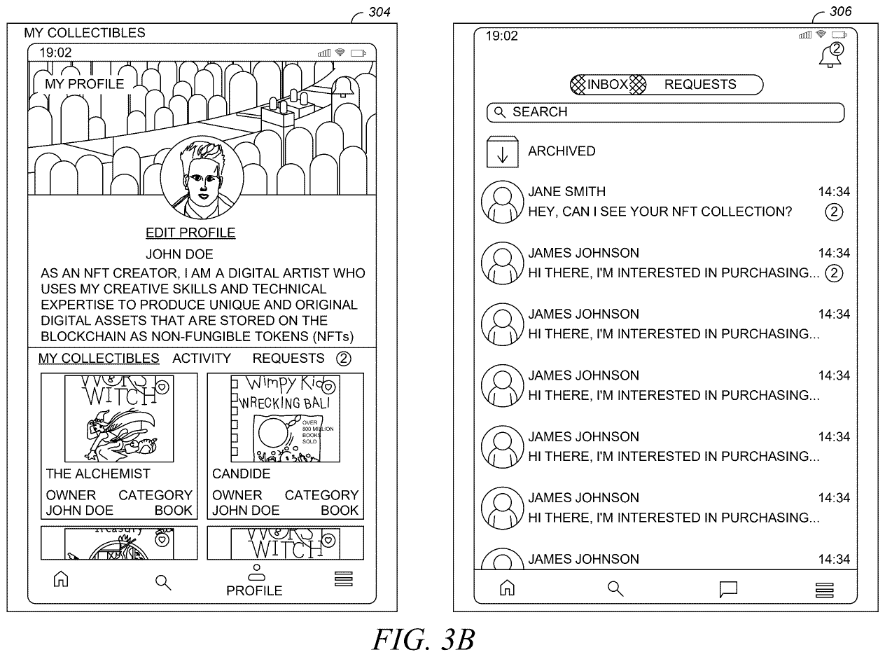

FIGS. 3A and 3B illustrate an example user profile page of the mobile application 200 for displaying user account information. The example profile page 300 may display a user's name, account number, and quick access to notifications such as alerts and market news. The profile page 300 further comprises information relating to notices concerning collectible assets such as trades, an event calendar, configuration, and history. Access to user settings may also be displayed on the profile page 300, such as account management, 2-Factor authentication, and research and education.

In addition, FIGS. 3A and 3B illustrate an example of a user message display page 302. The example messages page 302 comprises a message organization scheme, such as an inbox, private messages, public messages, sent messages, and a trash selection. In FIG. 3B, a profile screen 304 illustrates example details of a user profile, and a messages screen 306 illustrates example messages.

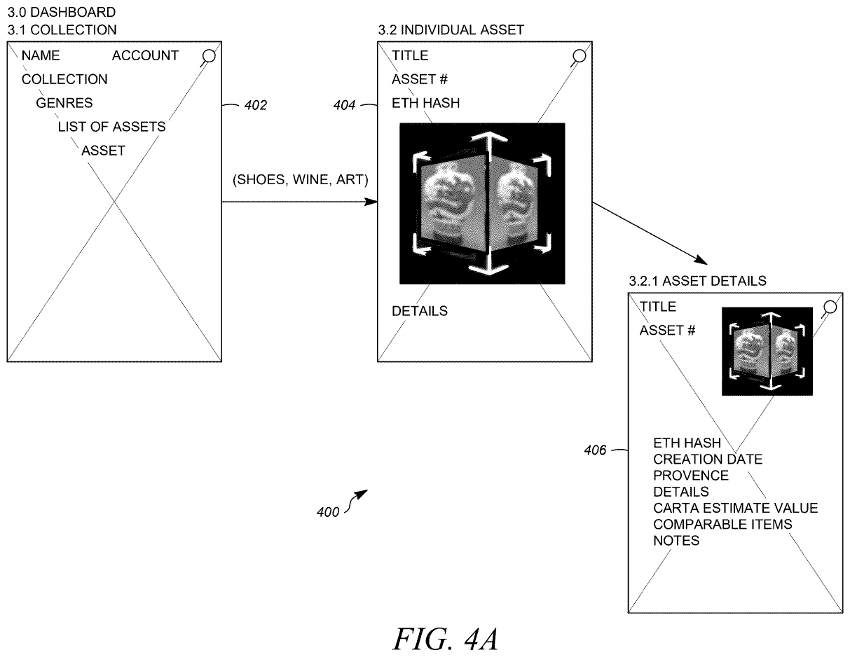

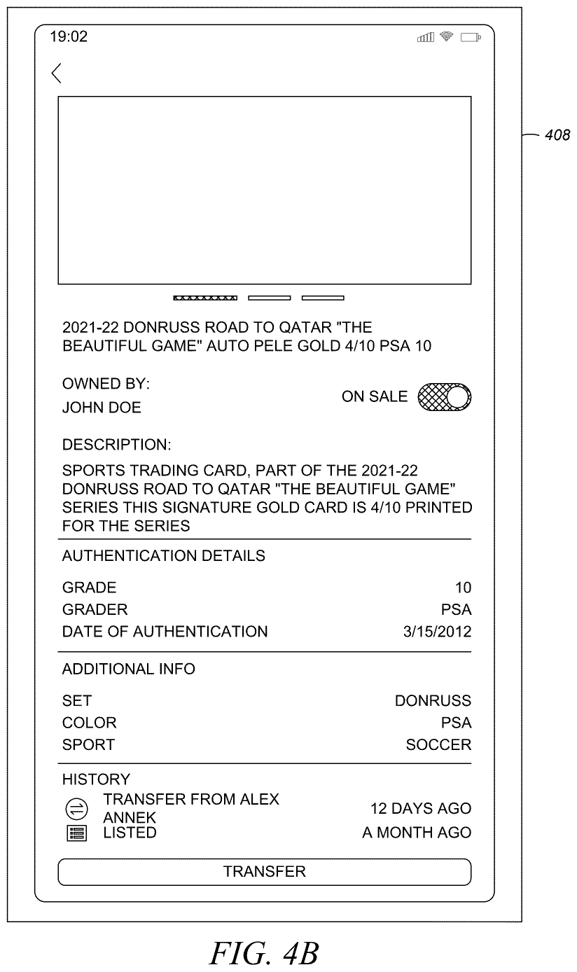

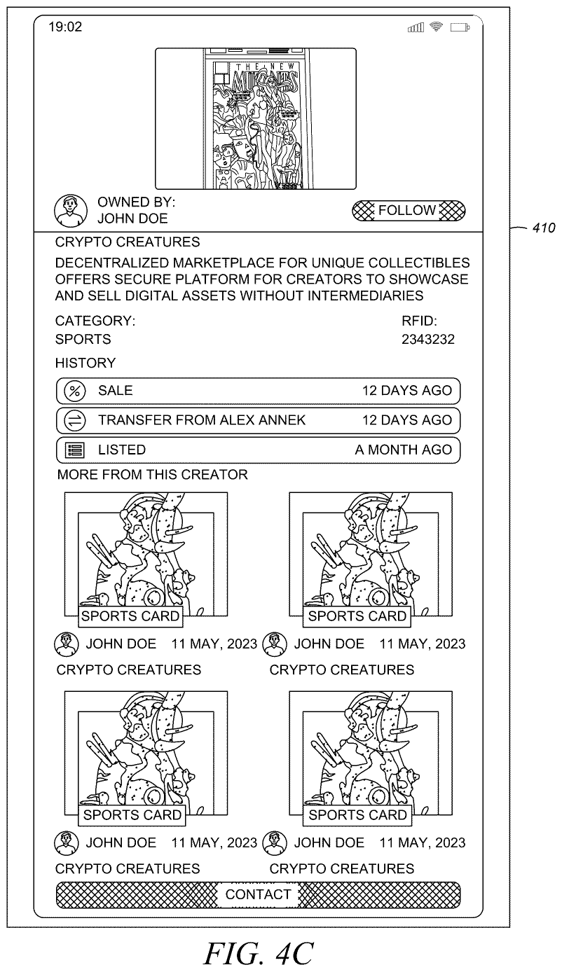

The mobile application 200 further comprises an example searchable marketplace 400, as generally indicated in FIG. 4A. The example searchable marketplace 400 shown in FIG. 4A comprises a collection page 402 for displaying listings of collectible assets. The example searchable marketplace may be filtered to accommodate broad searching of a specific genre of collectible asset. Genres may comprise lists of assets grouped together and be further searchable for individual assets meeting certain search criteria specified by the user. For example, a genre may be titled “shoes,” “wine,” or “art.”

In addition, FIG. 4A illustrates an example of an individual asset listing page 404. The example individual asset listing 404 comprises the asset's title, asset's number, the ETH Hash identifying the asset, and any appropriate details to describe the asset. A figure of the asset is also displayed to identify the specific collectible asset offered for sale.

Further, FIG. 4A illustrates an example of an asset details page 406 displaying a specific collectible asset's identification information. Such identification information may include an ETH Hash, an asset creation date, provenance history, relevant details relating to the asset, a Carta estimated value of the asset, comparable items, and any notes relevant to the asset listing.

FIG. 4B illustrates an example asset details screen 408 illustrating information about a specific asset. FIG. 4C illustrates an example asset information screen 410 illustrating additional information about an asset, such as RFID information and other assets from a same creator.

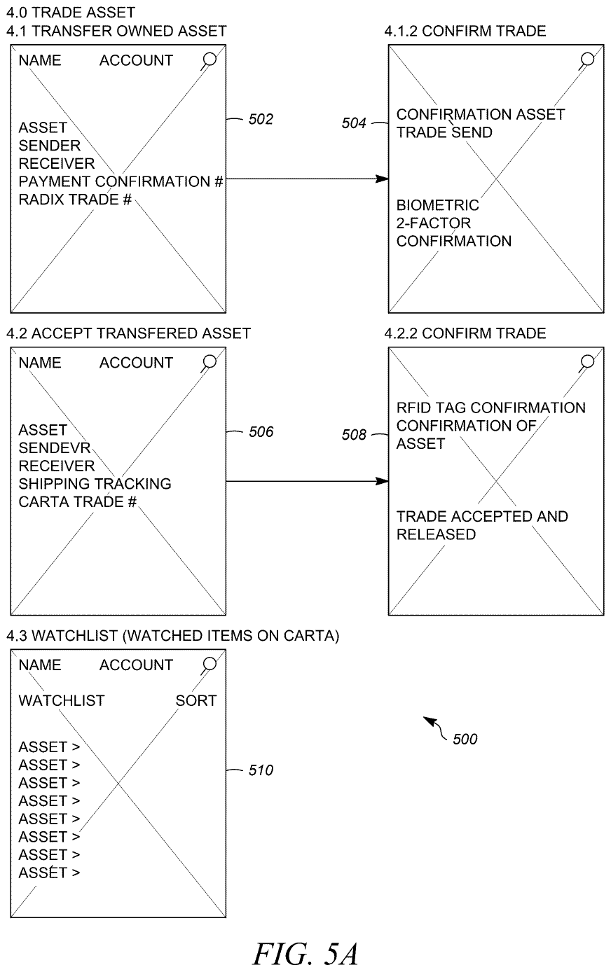

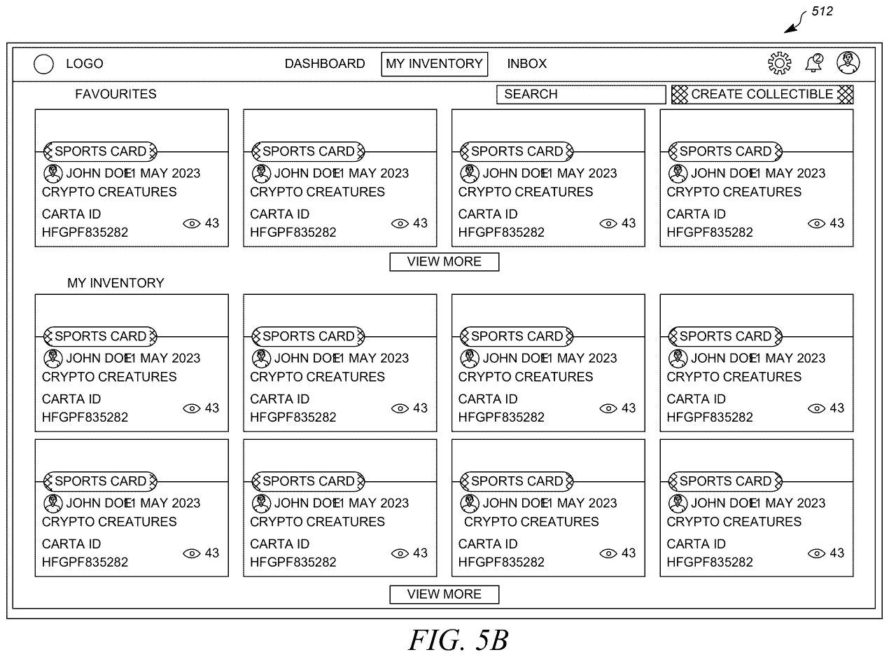

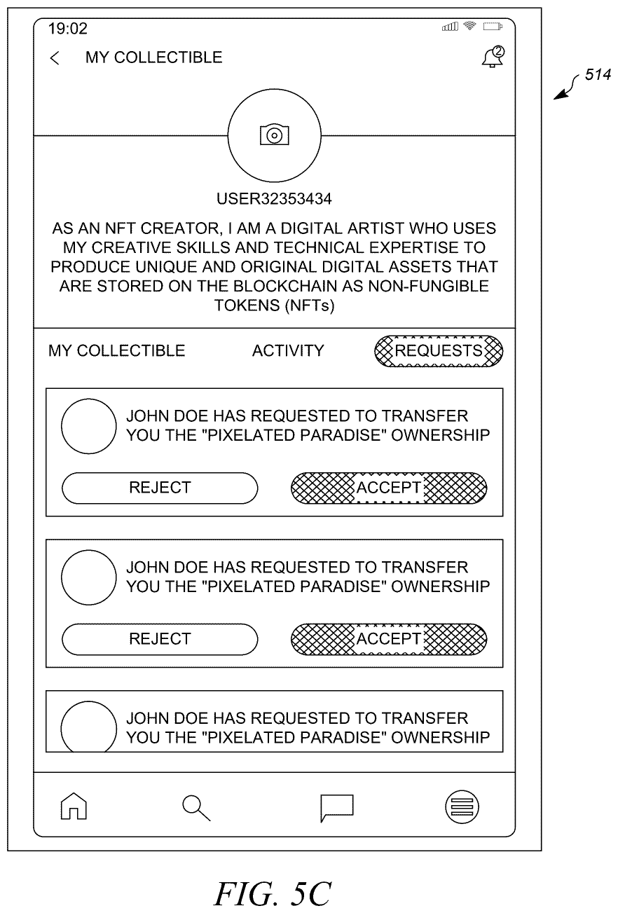

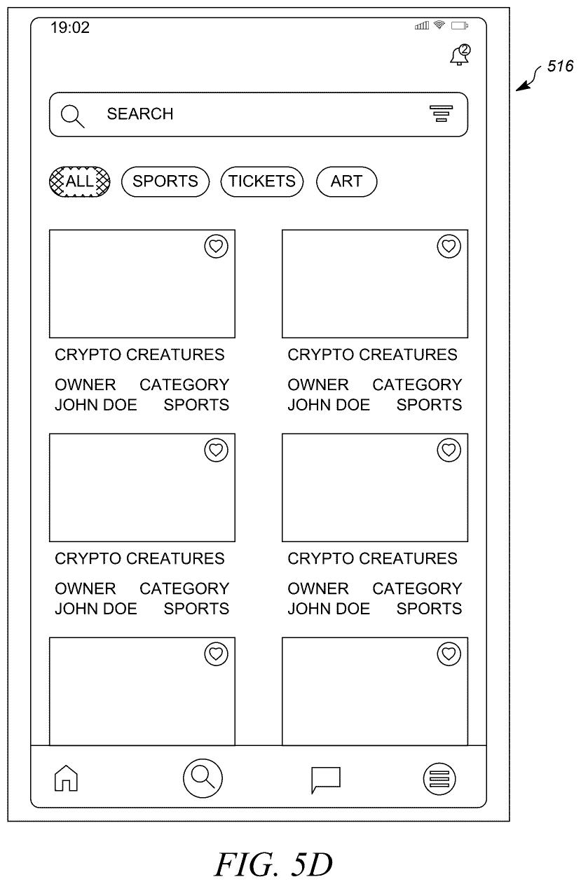

The mobile application 200 may include a system 500 to facilitate transactions of collectible assets, as generally illustrated in FIG. 5A-5D. FIG. 5A-5D illustrate example displays of a user's device when transferring/trading a collectible asset.

FIG. 5A shows a first example display 502 comprising information relating to transferring an owned collectible asset from the seller's perspective. The example display 502 includes information such as the selling user's name, selling user's account number, asset name, sender name, receiver name, payment confirmation number, and Carta trade number.

FIG. 5A shows a second example display 504 comprising information relating to confirming the transfer/trade of the collectible asset from the seller's perspective. The example display 504 comprises information such as confirmation of the asset and confirmation of the transfer by biometric and/or 2-Factor authentication.

FIG. 5A shows a third example display 506 comprising information relating to accepting a transferred asset from the buyer's perspective. The example 506 comprises display information such as the buying user's name, buying user's account number, asset name, sender name, receiver name, payment confirmation number, and Carta trade number.

FIG. 5A shows a fourth example display 508 comprising information relating to confirming the transfer/trade of the collectible asset from the buyer's perspective. The example display 508 comprises information such as confirmation of the asset and confirmation of the transfer by biometric and/or 2-Factor authentication.

FIG. 5A shows a fifth example display 510 comprising information relating to a user's watchlist of collectible assets. The example display 510 comprises information organized in a sortable list of collectible assets showing the asset name, user's name, and user's account number.

FIG. 5B illustrates an example dashboard screen 512, showing an inventory of assets of a user. FIG. 5C illustrates an example request screen 514, showing requests received by a user. FIG. 5D illustrates an example search screen 516, which may allow a user to search for various assets.

The mobile application 200 may implement a method of generating a Non-Fungible Token (NFT) for each physical collectible asset listed on the platform. Each physical collectible asset listed on the platform may be represented by a unique Non-Fungible Token (NFT) stored on the blockchain. The NFT serves as a digital certificate of ownership and provides a verifiable link between the digital representation and the physical asset.

Further, the mobile application 200 may provide a method of scanning a RFID/NFC tag on a physical asset to link a particular physical asset to its NFT digital representation on the blockchain. Such an RFID tag may be encoded by the merchant partner or authenticator and registered on the Carta digital platform. The tag may be in many different physical forms depending on the type of physical asset. The tag may be relatively small in size and be made of a tamper proof material. Such a tag may not require a battery, as it may absorb power from a scanning device in some example embodiments.

The scanning process uses a mobile device and NFC reader hardware to obtain information from the RFID tag and reference a corresponding digital listing on the digital platform. A user may quickly and accurately find a physical asset's digital representation in the mobile application's searchable marketplace if such an NFT digital listing exists.

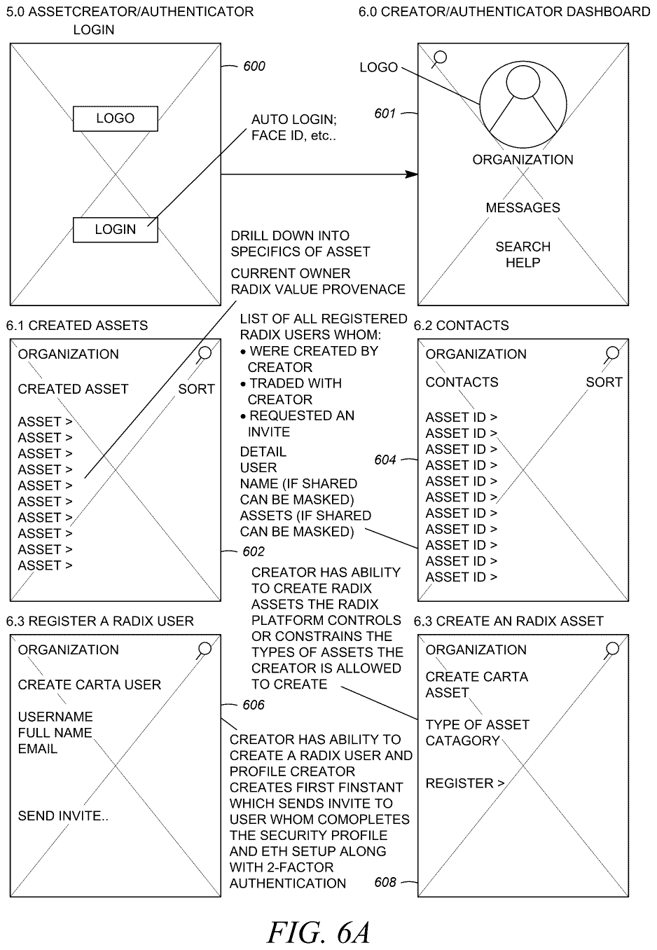

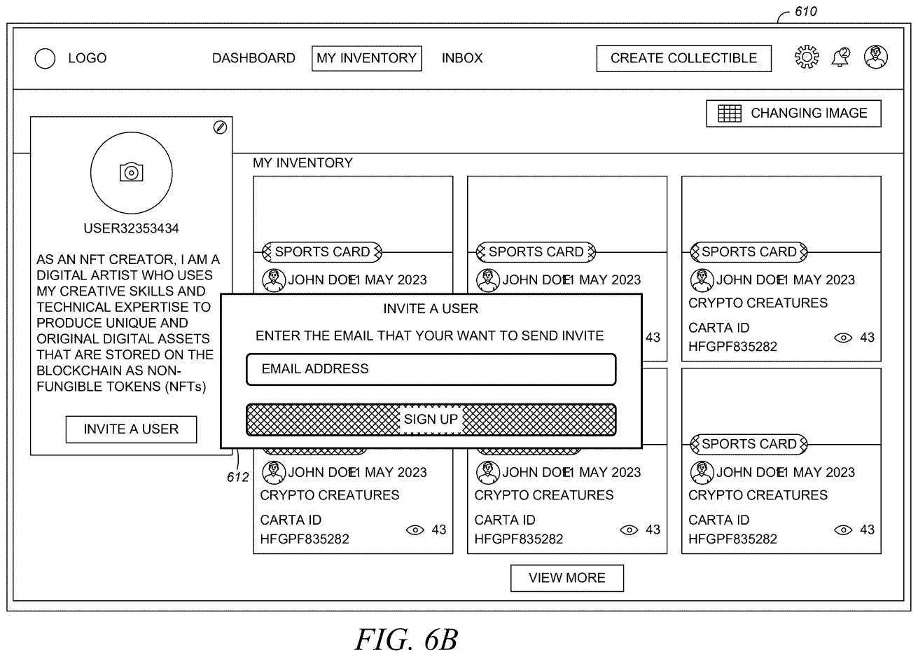

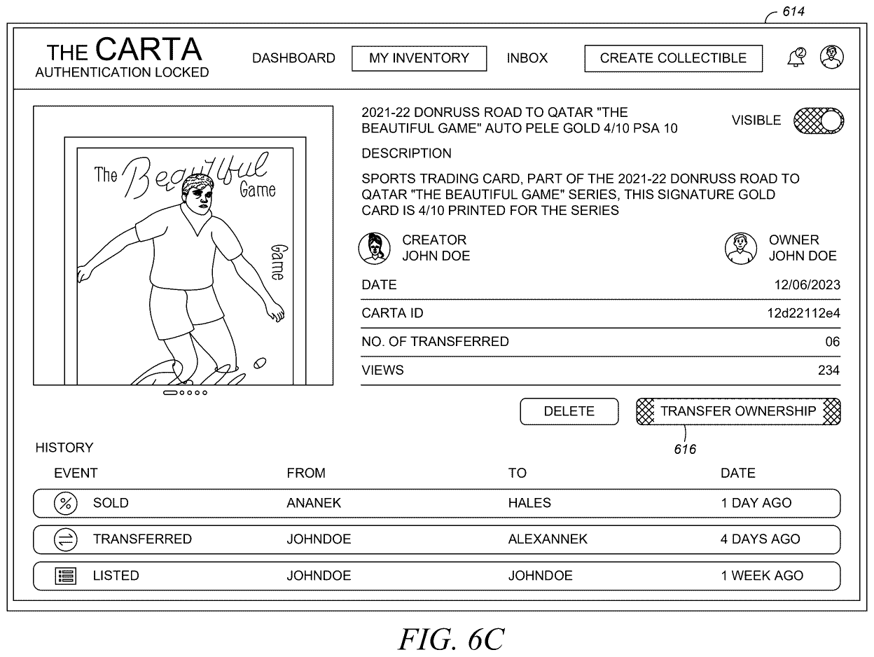

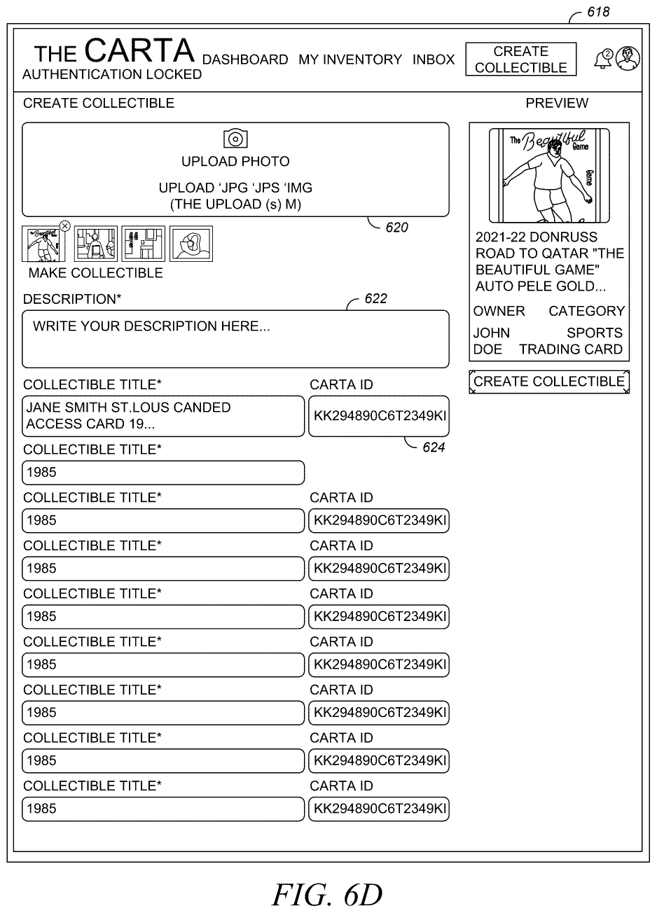

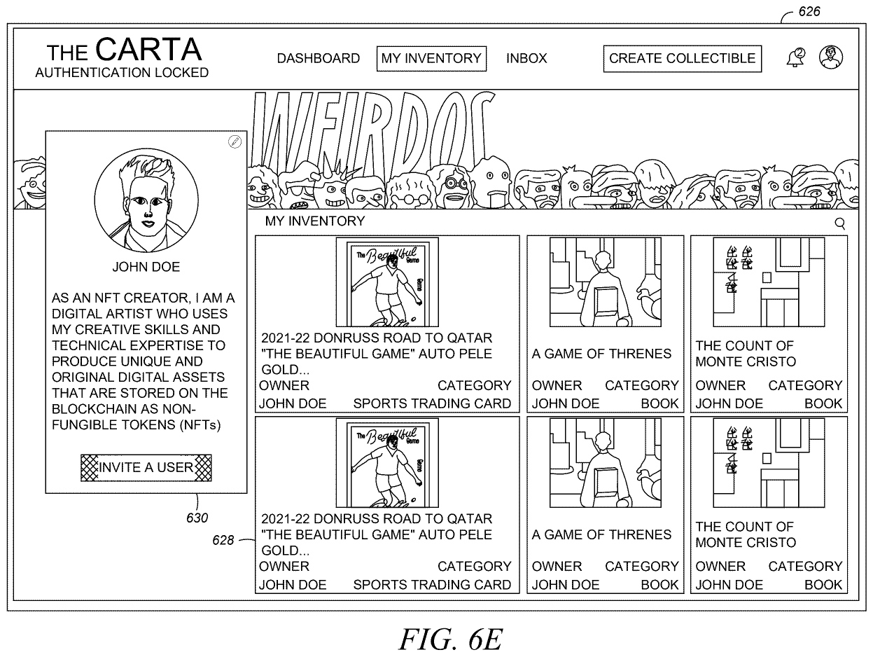

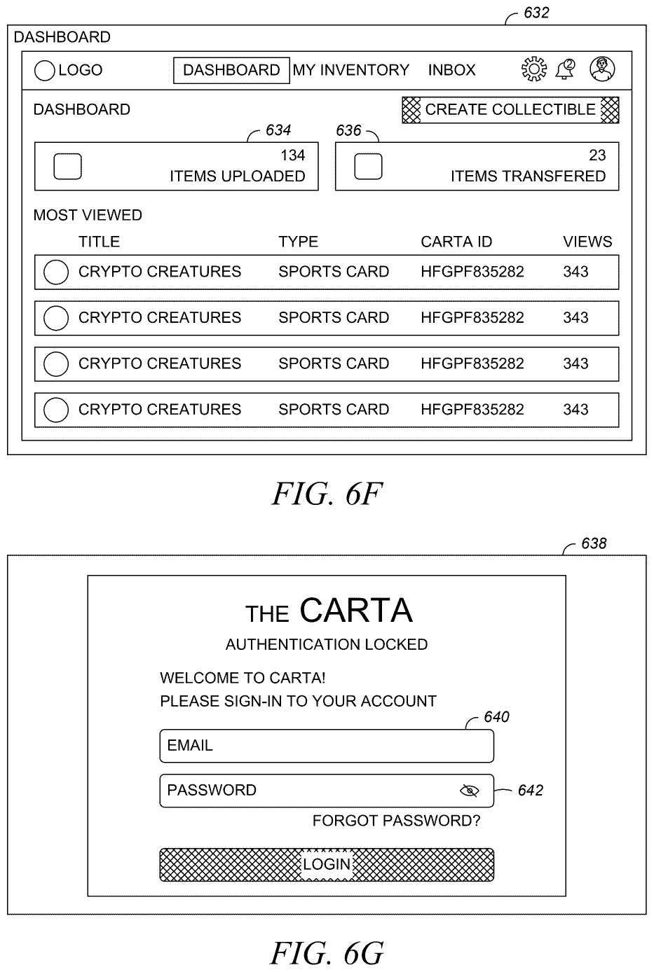

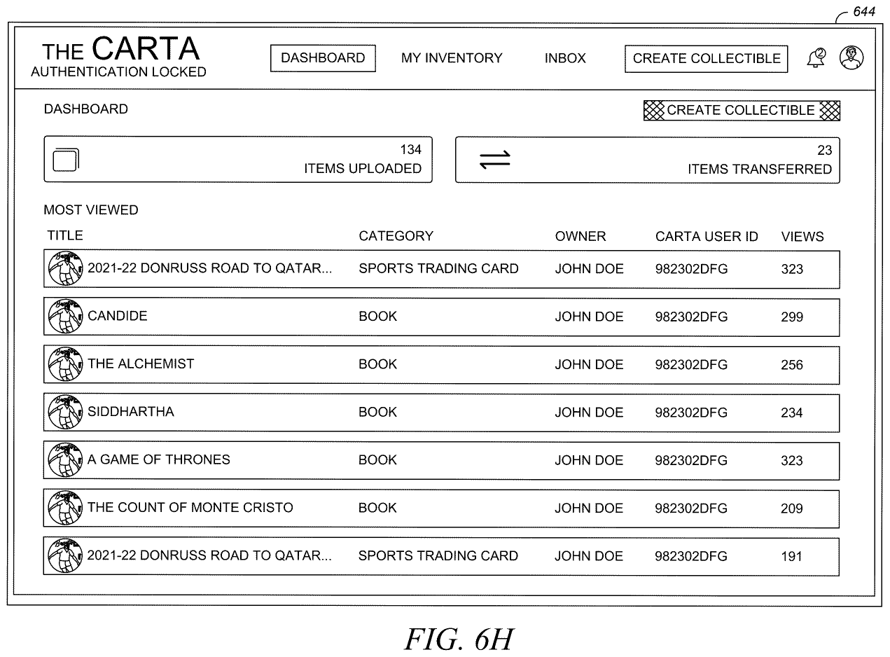

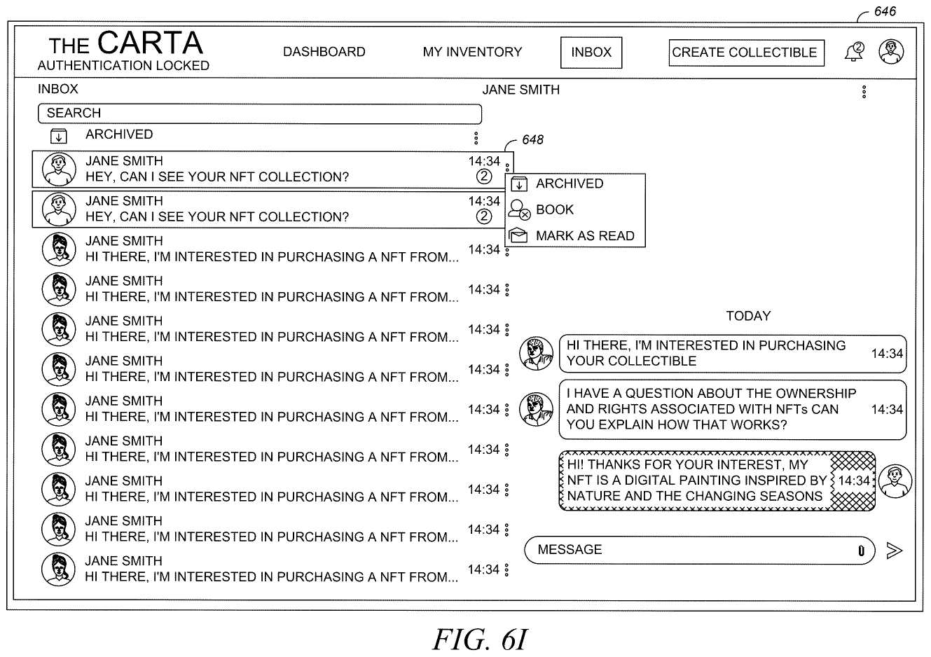

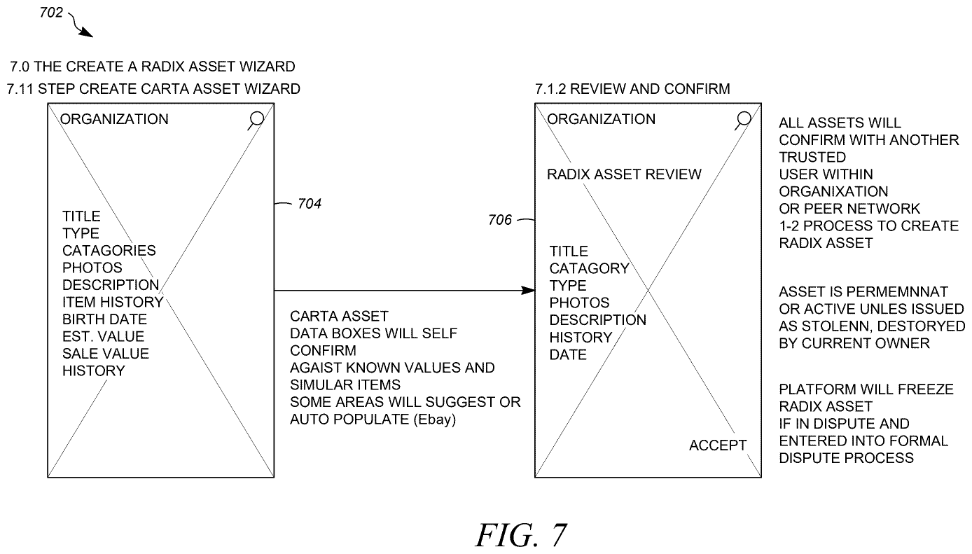

FIGS. 6A-7B illustrate an example of creating an asset for listing on the digital platform. A user creates a digital asset by inputting various information into a particular Carta Assert Wizard 702, as generally illustrated in FIG. 7. The Carta Asset Wizard 702 authenticates the provided information and completes an asset review. Once reviewed and confirmed, the digital asset may be listed for sale on the searchable marketplace provided by the digital platform.

FIG. 6A shows example user display interfaces illustrating the asset creator's login page and registration to become a Carta user and create digital assets. FIG. 6A illustrates an example login page 600, and ad a creator dashboard page 601. FIG. 6A at 6.1 shows a created assets page 602, which may list the created assets owned by a particular user. FIG. 6A at 6.2 shows a contacts page 604. The contacts page 604 may include a record of an interaction a user has had with another in the marketplace, which may include interactions of a partner and a user. The contacts page 604 may be searchable and list previous transactions a partner has had with a user. In some example embodiments, a contacts page (or customer page on a partner side), may include a record list of any user interaction the partner has with a stored user in the past, and in the present. The record list may be searchable, and may include any transactions the partner has had with the user. FIG. 6A at 6.3 shows a register radix user page 606, and a create radix asset page 608.

FIG. 6B illustrates an example inventory screen 610, including a user invitation window 612. FIG. 6C illustrates an example collectable information screen 614, including an option to transfer ownership 616. FIG. 6D illustrates an example create collectable screen 618, which allows a user to upload a photo 620 of the asset, write a description 622 of the asset, create a title 624, etc.

FIG. 6E illustrates an example user inventor screen 626, illustrating multiple assets 628 of a user 630. FIG. 6F illustrates an example dashboard screen 632, depicting items uploaded 634 and items transferred 636. FIG. 6G illustrates an example login screen 638 for entering an email 640, and a password 642. FIG. 6H illustrates an example dashboard viewing screen 644 illustrating a list of items by most viewed. FIG. 6I illustrates an example inbox screen 646, illustrating searchable messages 648.

FIG. 7 shows an example user interface illustrating the creation of a digital asset. FIG. 7 at 7.1.1 shows an example display 704 comprising information regarding an asset's title, type, categories, photos, description, item history, birth date, estimated value, sale value, and history. Upon a review and confirm step 706 shown in FIG. 7 at 7.1.2, the input data may self-confirm against known values and similar items. Alternatively, or in addition, some input data may produce suggestions or auto populate from referenced websites (e.g., eBay). Some or all assets may undergo review with a trusted member organization or peer network for authentication before final confirmation. Once the asset is confirmed, a listing may be created by the user. The asset information may be permanent or active unless issued as stolen or destroyed by the current owner of a physical asset. If the digital asset is identified to be involved in a dispute, the digital platform may freeze the Carta asset and complete a formal dispute process before the asset may be traded again.

Upon successful creation of a digital asset, the asset can be listed on a searchable marketplace. The marketplace provides a comprehensive catalog of assets, allowing users to browse through various categories, such as art, sports memorabilia, rare coins, or historical artifacts. Users can filter and search for assets based on parameters such as rarity, artist, historical significance, or asking price.

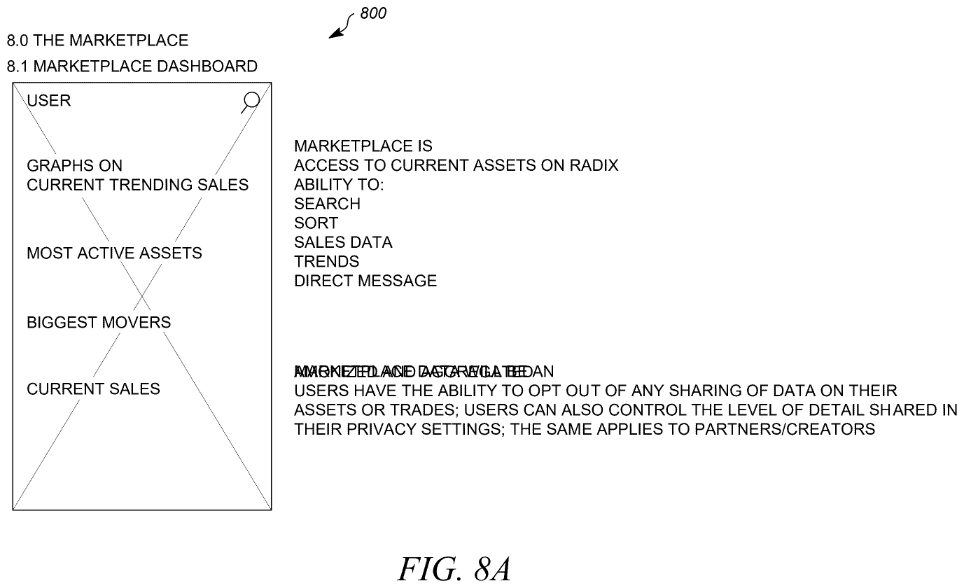

FIGS. 8A and 8B show an example user interface of a marketplace dashboard 800. The example marketplace dashboard 800 comprises a plurality of asset metrics to assist users in navigating the searchable marketplace. Such asset metrics may include graphs on current trending sales, lists of most active assets, information on biggest movers, and current sales of collectible assets. Additionally, FIG. 8B shows features allowing users to search assets, sort assets, access sales data and trends, and direct message other users, as shown on a search screen 802. In some example marketplace settings, users may opt out of sharing data pertaining to their assets or trades of assets and control the level of shared data according to their preferred privacy settings.

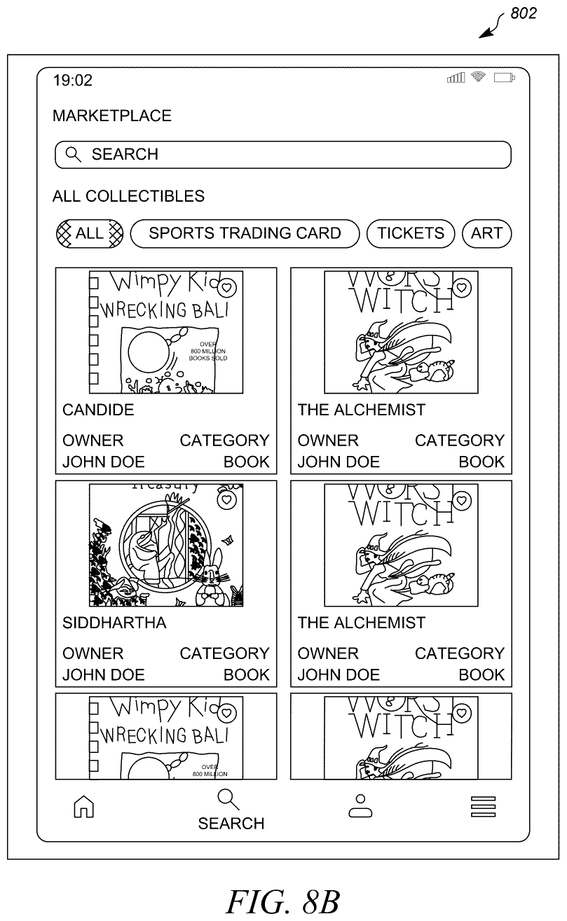

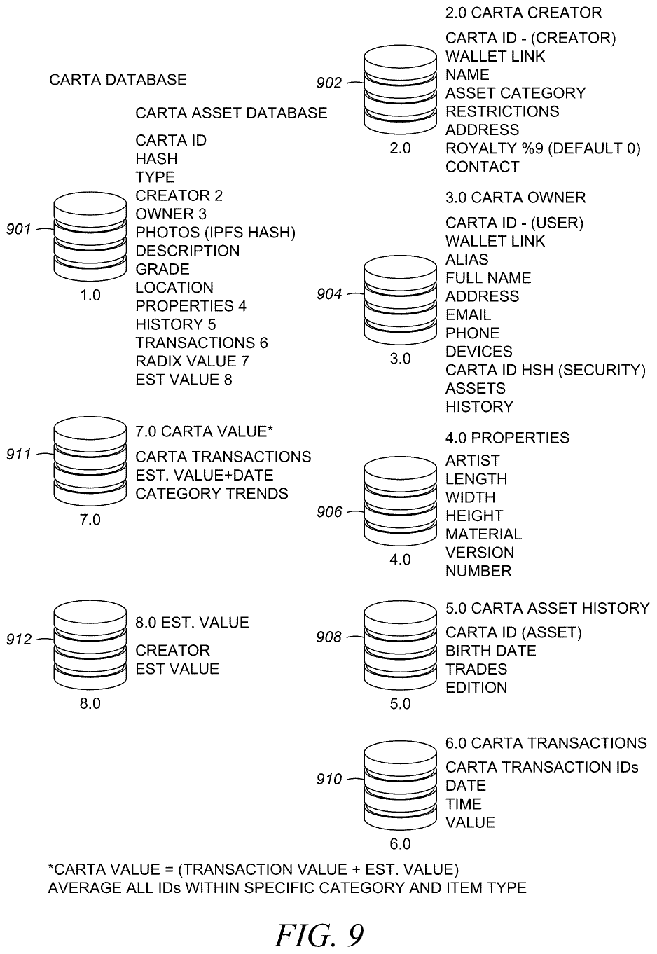

FIG. 9 illustrates example values that may be stored in one or more databases in the system. For example, a carta asset database 901 may store identifiers, hash values, type values, creator and owner information, photos, description data, grade values, location data, property information, history details, transaction data, radix values, estimated value data, etc. FIG. 9 at 2.0 details example variables considered by the Carta creator 902. Such variables may include a Carta ID, a wallet link, name, asset category, restrictions, history, transactions, address, a royalty value, and contact information.

FIG. 9 at 3.0 details example variables pertaining to the Carta owner 904. Such variables may include a user's Carta ID, wallet link, alias, full name, address, email address, phone number, Carta ID hash used for security purposes, list of assets, and history. FIG. 9 at 4.0 details example properties of an asset used in the Carta database 906. Such properties may include the asset's artist name, physical dimension values such as height and width, physical material information, version/model information, and number or edition identification.

FIG. 9 at 5.0 details example variables considered in a Carta asset history for a collectible asset 908. Such variables may include an asset's Carta ID, birth date, past trade information, and identifying edition information. FIG. 9 at 6.0 details example variables used in a Carta transaction 910. Such variables may include Carta transaction IDs and the date, time, and value of a particular transaction. A carta value database 911 may store transaction data, estimated value and date data, category trend data, etc. An estimated value database 912 may store creator data, value data, etc.

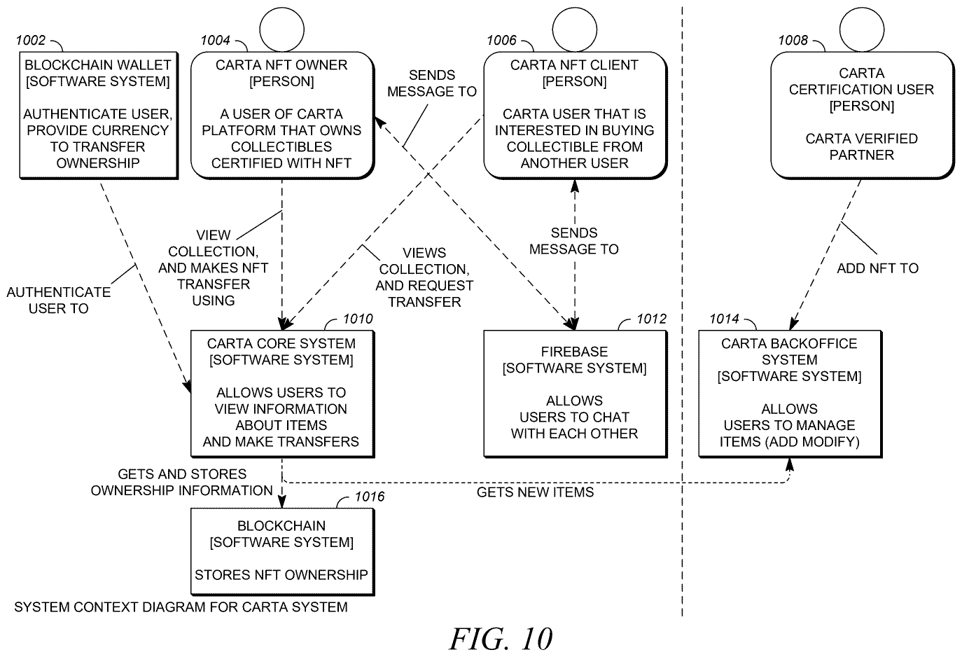

FIG. 10 shows an example block diagram of the digital platform interacting with the blockchain. The digital platform utilizes NFT functionality built into the Polygon network and smart contracts to facilitate transactions and the transfer of digital assets. In a preferred embodiment, the digital platform may operate on the Polygon network and be compatible other types of coins (NFTs) to facilitate transfer of different asset types. Further, the digital platform may include a scanning feature for scanning an RFID tag on a physical asset. This may allow the NFT corresponding to the physical asset to be referenced/located on the digital platform. Upon scan, if a connected digital asset exists, the digital platform retrieves listing information about the NFT and connected physical asset including token details and authentication information.

The system may implement a method of transferring a physical asset after a transaction of the digital asset (NFT) has been successfully completed. Physical asset transfer may occur after funds (e.g., a cryptocurrency) have been successfully transferred from the buyer's wallet to the seller's wallet.

As shown in FIG. 10, a blockchain wallet 1002 may authenticate a user to a core system 1010. An NFT owner 1004 may access the core system 1010 to view a collection and make NFT transfers. An NFT client 1006 may access the core system 1010 to view a collection and request a transfer.

The system includes a firebase 1012, which allows users to chat with each other (e.g., by sending messages between the NFT owner 1004 and the NFT client 1006). The core system 1010 may obtain and store NFT ownership information on a blockchain 1016. A verified partner 1008 may add NFTs to a back office system 1014, and the core system 1010 may communicate with the back office system 1014 regarding new items.

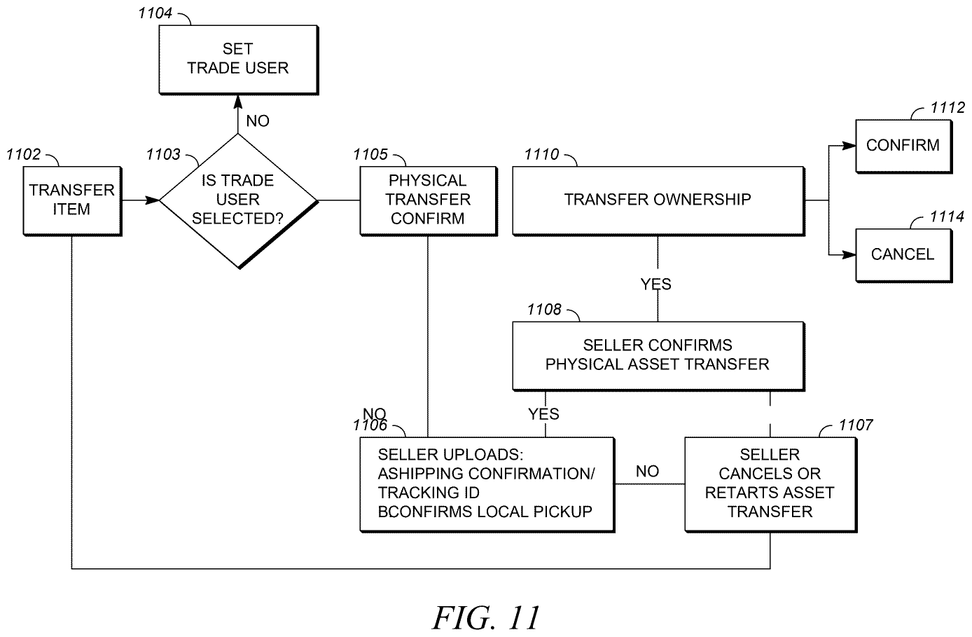

FIG. 11 shows a block diagram of an example method of transferring a physical asset after successful transaction completion. Upon successful transaction, including transfer of appropriate funds, a seller may select a transfer option 1102. Such transfer options may include face to face transfer, postal shipping, or some other method available depending on location of physical asset. For example, if a user trade is not selected at 1103, the system may set a trade user value at 1104.

If a shipping option is selected at 1105 (e.g., a physical transfer confirmation), the digital platform will collect shipping information 1106 from both the seller and buyer such as address, tracking information, and other relevant details. The digital platform may not allow the transfer of the NFT digital asset until delivery is confirmed from the shipper via confirmation from a tracking record. For example, a seller may cancel or restart an asset transfer at 1107. Upon successful confirmation 1108, the seller may now transfer the NFT digital asset to the buyer at 1110. The digital platform may not allow the transfer of the NFT digital asset until delivery is confirmed from the buyer via confirmation at 112, such as via confirmation by the buyer of the RFID tag on the item from the buyer's mobile device on the platform, thus confirming the physical ownership. A transaction may be cancelled at 1114, such as when the RFID tag is not confirmed by the buyer within a specified time period (e.g., 24 hours, three days, one week, etc.).

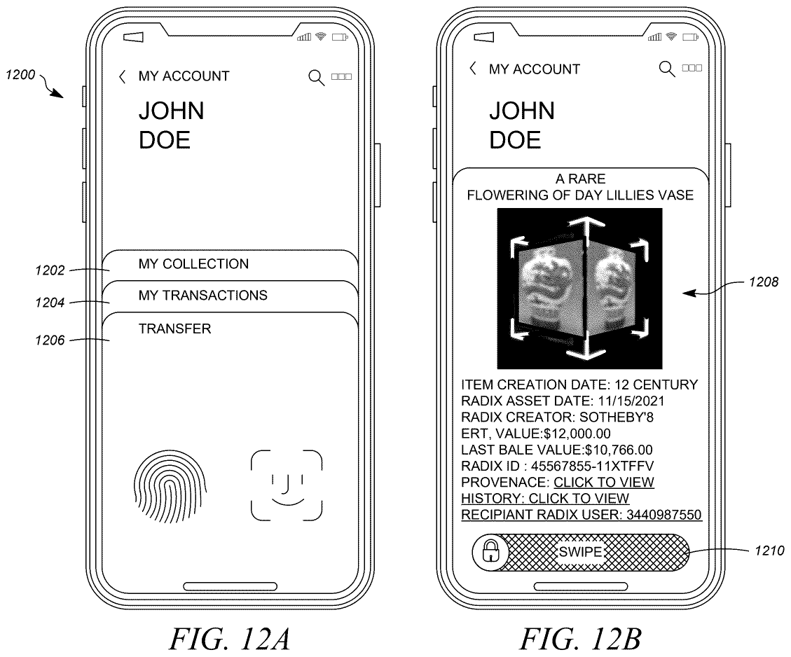

FIG. 12A shows an illustration of an example interface display 1200 of the mobile application 200 on a user's device. The interface comprises an account page for displaying a user's collection of digital collectible assets 1202, a record of previous transactions and trades 1204, and a 2-Factor authentication method of confirming transfer of a digital asset 1206. Further, FIG. 12B shows an example display of an NFT of a digital asset before it is confirmed to be transferred by the seller. The confirmation display 1208 may include information such as item creation date, Carta asset date, Carta creator identification information, estimated asset value, last sale value, unique Carta ID, provenance information, a link to historical information, the address of the recipient Carta user receiving the asset, etc. The seller may provide 2-Factor authentication and swipe 1210 a confirmation control before sending the asset.

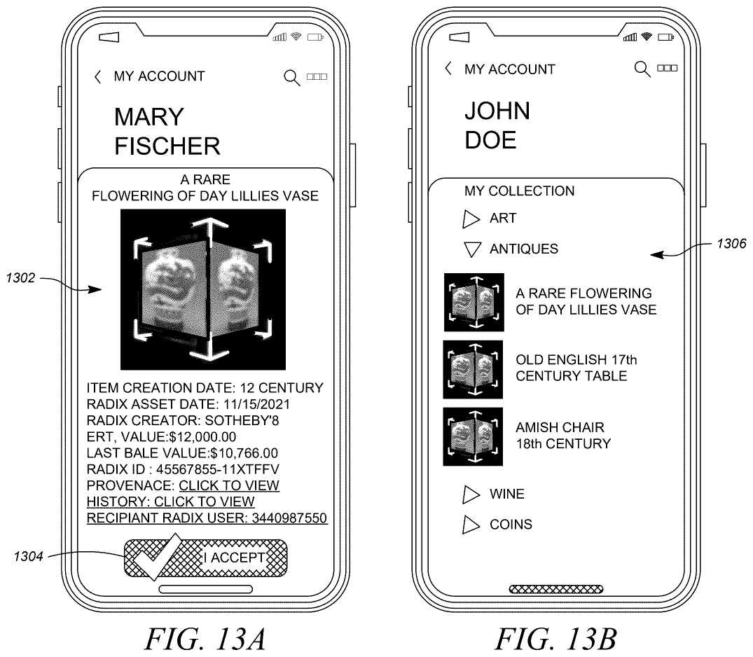

FIG. 13A shows an illustration of an example interface display of the mobile application 200 on a user's device. The interface comprises an account page 1302 for a buyer accepting a transfer of a digital collectible asset. The buyer may accept transfer 1304 of the asset by confirming in the mobile application. FIG. 13B further shows an account page 1306 of a user and the user's collection of digital assets. A collection may be organized in categories such as art, antiques, wine, coins, etc.

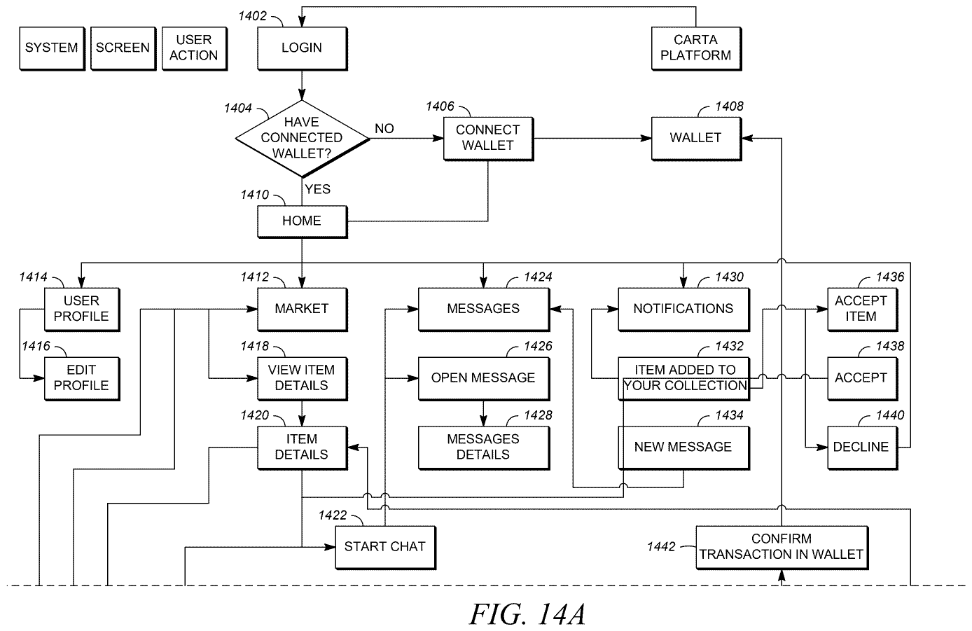

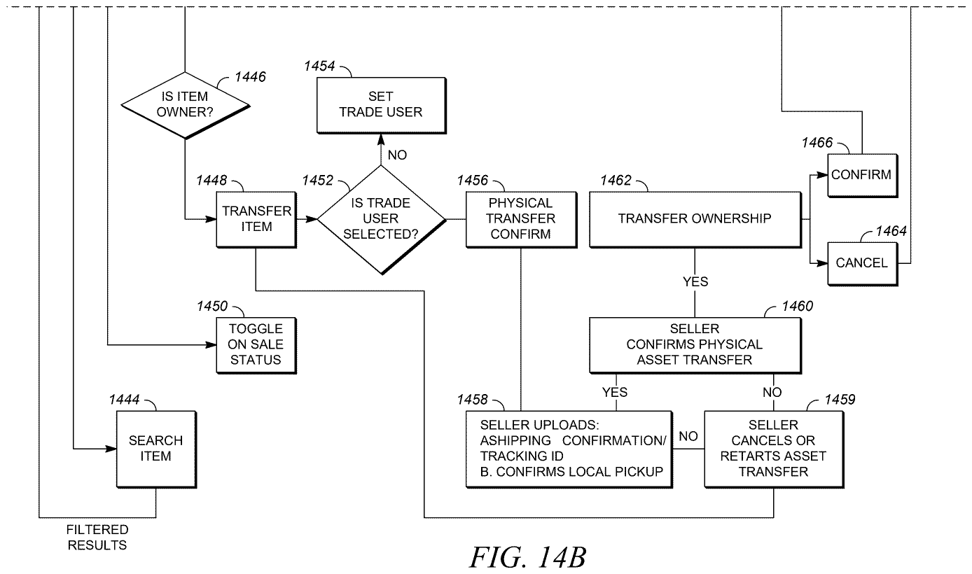

FIGS. 14A and 14B illustrate a flowchart depicting an example method for processing a secure transaction comprising transferring funds in connection with an asset sale, updating asset information on a blockchain, and facilitating physical asset transfer post-transaction.

In some examples, a user may login to an asset tracking platform at 1402. If the user does not have a connected wallet at 1404, a connect wallet operation is performed at 1406 to connect to a wallet 1408 for the user. If the user has a connected wallet at 1410, the process proceeds to a home 1410 location. From the home location 1410, the user may access a user profile 1414 and edit the profile at 1416.

The user may access a market 1412, and may perform a view items details operation at 1418 to view details of various asset items at 1420. The user may generate messages 1424, such as via a chat 1422. The user may be able to open received messages at 1426, and view message details at 1428.

As another option, the user may view notifications at 1430, such as items added to a collection at 1432. If an item is to be added to a collection, the user may accept the item at 1436, or decline the item at 1440. The user may also accept notifications at 1438, and may receive new messages at 1434.

In some examples, a user may confirm a transaction in a wallet at 1442. For example, referring to FIG. 14B, the system may determine whether a user is an item owner at 1446, and transfer the item at 1448. If trade user is not selected at 1452, the process may set trade user at 1454. If trade user is selected at 1452, a physical transfer confirmation may occur at 1456. For example, the seller may upload shipping confirmation and/or a tracking identifier, and confirm a local pickup, at 1458.

The seller may cancel or restart an asset transfer at 1459, or confirm a physical asset transfer at 1460. Ownership of the item is transferred at 1462, and may be either confirmed at 1466 or cancelled at 1464. If ownership of the item is confirmed to transfer at 1466, the item may be added to a wallet 1408 of the user.

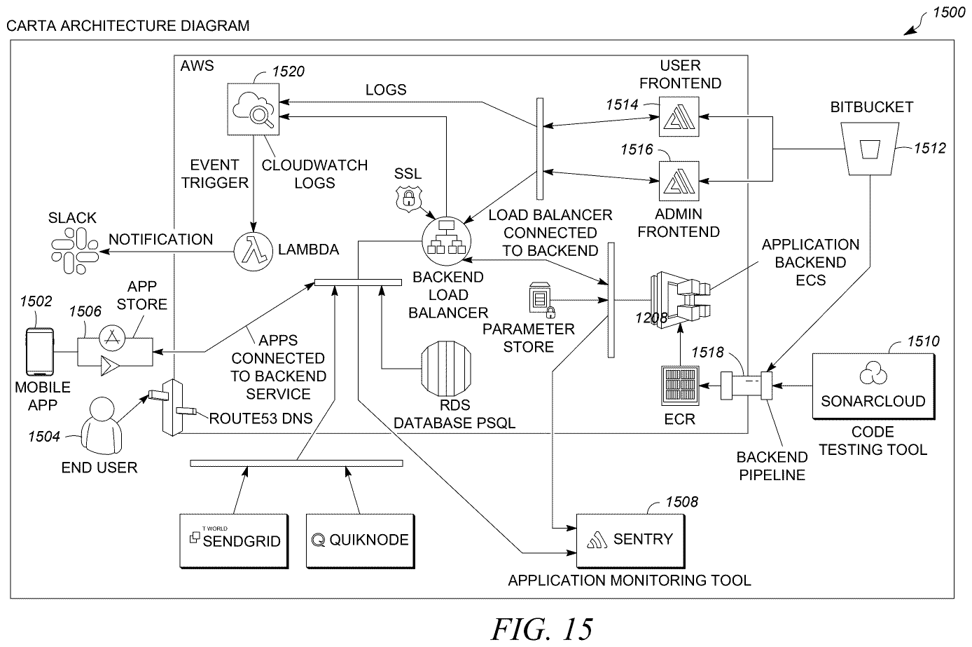

FIG. 15 illustrates an example architecture for an asset tracking system 1500. As shown in FIG. 15, the system 1500 may include a mobile application 1502, which can be operated by an end user 1504 to access an app store 1506. The system 1500 also includes an application monitoring system 1508, a code testing tool 1510, and a bitbucket 1512. The code testing tool 1510 and the bitbucket 1512 may be coupled with a backend pipeline 1518.

In some examples, a process (e.g., executed on one or more servers) may include a user front end 1514 and an admin front end 1516, which may receive data from the bitbucket 1512. The system 1500 may include multiple load balancers, parameter stores, databases, etc., and data from the system may be stored in logs 1520.

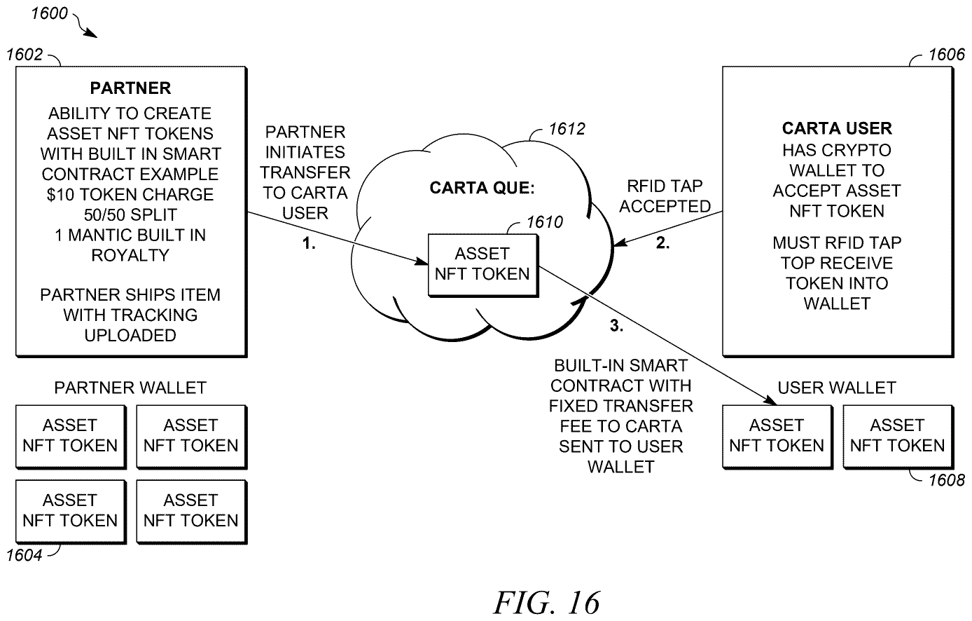

FIG. 16 illustrates an example workflow 1600 for a partner to create an asset NFT token and send to a partner customer. For example, a partner 1602 may have a user wallet including multiple asset NFT tokens 1604, and a user 1606 may have a user wallet including one or more asset NFT tokens 1608.

As shown in FIG. 16, the partner 1602 may initiate a transfer of a physical asset to the user, which may be associated with an asset NFT token 1610. The asset NFT token 1610 may be processed, stored in, etc., a queue 1612. The user 1606 may then provide an RFID tap, such as tapping an RFID tag of a physical item associated with the asset NFT token 1610. After the RFID tap is accepted, the asset NFT token 1610 may be transferred to the user wallet, any may include a built-in smart contract with a fee (e.g., a fixed transfer fee, etc.).

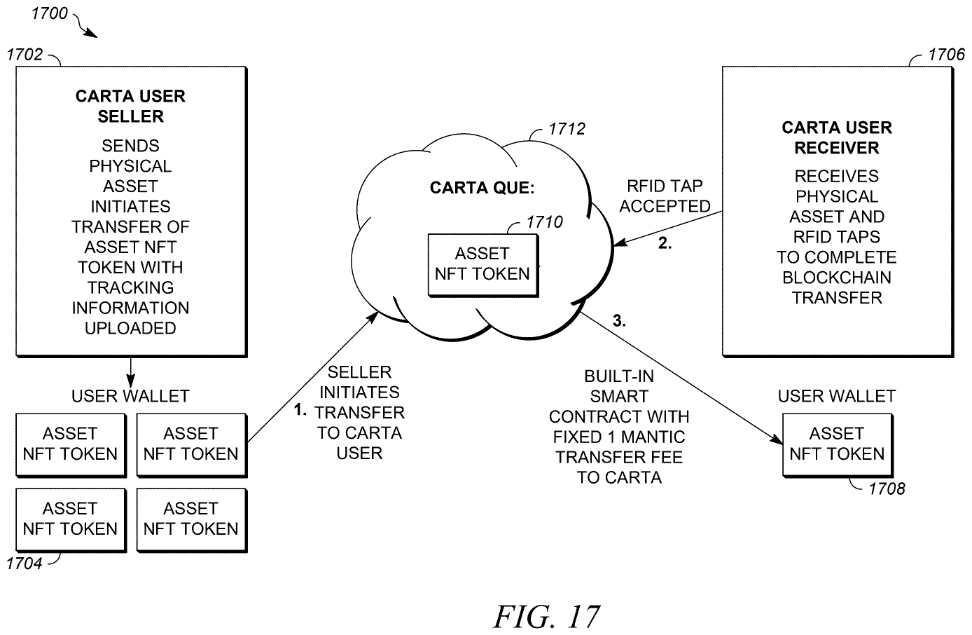

FIG. 17 illustrates an example workflow 1700 for a user to transfer an asset to another user. For example, a user seller 1702 may have a user wallet including multiple asset NFT tokens 1704, and a user receiver 1706 may have a user wallet including one or more asset NFT tokens 1708.

As shown in FIG. 17, the partner user seller 1702 may initiate a transfer of a physical asset to the user receiver 1706, which may be associated with the asset NFT token 1710. The asset NFT token 1710 may be processed, stored in, etc., a queue 1712. The user receiver 1706 may then provide an RFID tap, such as tapping an RFID tag of a physical item associated with the asset NFT token 1710. After the RFID tap is accepted, the asset NFT token 1710 may be transferred to the user wallet, any may include a built-in smart contract with a fee (e.g., a fixed 1 matic fee, etc.).

In some examples, system actors may include a user, a partner, an admin, etc. Example system modules may include user onboarding (e.g., sign up such as connecting a wallet, login such as verification through a wallet, etc.), explore marketplace, view inbox, view my collections, view/change profile, view notifications, view/change settings, etc. The User Onboarding module may include processes for logging in, either using an email address or by connecting with a digital wallet. The User Onboarding module allows existing users to invite new users by creating accounts through referral codes, or by connecting with a digital wallet. Users may have the capability to create digital assets in the form of Non-Fungible Tokens (NFTs), which are added to their collections or inventory. The system may allow users to view and manage their collections, organizing their digital assets as needed. Users can request the transfer of NFTs and manage the transfer of ownership of these digital assets. The system may feature an Explore Marketplace module, where users can discover new digital assets and collectibles available for viewing and purchase. The system may provide notifications to keep users informed about important updates and actions related to their accounts and activities. The system may include an inbox and in-app chat feature, facilitating communication and interaction among users within the platform.

In an example embodiment use case, the Super Admin includes a 2 factor MFA login. This use employs the admin actor. The preconditions for this system include that the Super Admin user account already exists in the system, and the Super Admin has a valid email address and password. The flow begins with the Super Admin navigating to the login page. The Super Admin then enters their email address and password, using a credentials email and password. The system verifies the entered email address and password. If the credentials are correct, the system logs in the Super Admin and redirects them to the Super Admin dashboard. However, if the email address or password is incorrect, the system displays an error message stating, “Invalid email or password!” The post conditions are that the Super Admin is successfully logged in and has access to the Super Admin dashboard.

In an alternative flow, if Two-Factor Authentication (2FA) is enabled in the admin settings, the Super Admin provides a verification code from the Google Authenticator app during login. The user opens the Google Authenticator app on their device. The system prompts the user to enter the 6-digit verification code generated by the app. If the user has not previously set up 2FA, they can do so by scanning a QR code or entering a key in the authentication app, as provided in the admin settings. The user then enters the verification code and clicks the “Verify” button. The system validates the entered code. If the code is correct, the user is successfully logged in and granted access to their account. If the code is incorrect, the system displays an error message stating, “OTP is not matched, please try again . . . ”. The success criteria include that the Super Admin can successfully log in using their email address and password and subsequently access the Super Admin dashboard.

In another example embodiment use case, the Super Admin includes a manages partners and view all partners listings capability. This use employs the admin actor. The preconditions are that the Super Admin is logged in with valid credentials, there is at least one Partner registered in the system, and there is at least one collectible (NFT) created by a Partner. The flow begins with the Super Admin navigating to the “Manage Partners” page from the left menu. The system then displays a list of all Partners, including information such as Partner Name, Email, Wallet Address, number of collectibles, status (enabled or disabled), and invite status (accepted or pending). The Super Admin can select a specific Partner to view more details by clicking on three dots next to the Partner's name. The system then displays a list of all the collectibles created by the selected Partner, and the Super Admin can view the details of each collectible by clicking on it. The post conditions indicate that the Super Admin can view the details of both the Partner and the listings of collectibles created by the selected Partner. The success criteria state that the Super Admin is able to view all the collectibles created by the selected Partner.

In another example embodiment use case, the Super Admin includes a manage partners and enable or disable account capability. This use employs the admin actor. The precondition for this use case is that the Super Admin is on the “Manage Partners” page or tab. The flow begins with the Super Admin navigating to the “Manage Partners” page from the left menu. Once there, the Super Admin clicks on the three dots next to each Partner's name. The Super Admin then selects either the “Enable” or “Disable” option. This action allows the admin to change the status of the Partner user account. If the “Enable” option is selected, the Partner user account is enabled, allowing the user to log in to the system. Conversely, if the “Disable” option is selected, the Partner user account is disabled, preventing the user from logging in. The post conditions state that the selected Partner user account will either be enabled or disabled based on the Super Admin's action. The success criteria are that the Super Admin can successfully change the status of the Partner user account, either enabling or disabling it as required.

In another embodiment use case, the Super Admin includes a manages users and view all users listings capability. This use employs the admin actor. The preconditions for this use case are that the Super Admin is logged in with valid credentials, there is at least one user registered in the system, and there is at least one listing created by the users in the system. The flow involves the Super Admin navigating to the “Manage Users” page from the left menu. The system then displays a list of all users, including information such as User Name, Email, Wallet Address, number of collectibles, account status (enabled or disabled), and invite status (accepted or pending). The Super Admin can view the details of each user by clicking on their entry in the list. The post conditions specify that the Super Admin can view the details of the users. The success criteria are that the Super Admin can successfully view all the listings of users.

In another embodiment use case, the Super Admin includes a manages user and enable or disable account capability. This use employs the admin actor. The preconditions for this use case are that the Super Admin is logged in with valid credentials, there is at least one user registered in the system, and there is at least one listing created by the users in the system. The flow begins with the Super Admin navigating to the “Manage Users” page from the left menu. Once there, the Super Admin clicks on the three dots next to each user's name. The admin can then change the status of the user account by selecting either the “Enable” or “Disable” option. If the “Enable” option is selected, the user account is enabled, allowing the user to log in to the system. Conversely, if the “Disable” option is selected, the user account is disabled, preventing the user from logging in. The post conditions state that the selected user account will either be enabled or disabled based on the Super Admin's action. The success criteria are that the Super Admin can successfully change the status of the user account, either enabling or disabling it as required.

In another embodiment use case, the Super Admin includes a manages collectible and/or listing capability. This use employs the admin actor. The preconditions for this feature include that the Super Admin is logged in with valid credentials, and there is at least one listing created by users in the system. The flow begins with the admin navigating to the “Collectible” section. Once there, the website displays a list of all collectibles or listings, providing information such as the Collectible Name, Category, Owner, and Carta ID. The admin can select a specific collectible or listing to view its details. Additionally, the admin can search for a desired collectible by its name. The post conditions specify that the admin can successfully view the listings and details of the collectibles. The success criteria are that the admin can view a comprehensive list of collectibles or listings and access detailed information for any selected collectible or listing.

In another embodiment use case, the Super Admin includes a view my collectible details capability. This use employs the admin actor. The preconditions for this feature include that the Super Admin is logged in with valid credentials, there is at least one Partner registered in the system, and there is at least one listing created by the Partner. The flow begins with the Admin navigating to the “Collectible” section. The Admin selects the collectible they want to view details of by clicking on the three dots next to the collectible. The website then loads the details page for the selected collectible. The details displayed on this page include the Collectible Name, Description, Image of the collectible, Owner Name (current owner), Creator Name, Number of transfers, Category, Created At date, Views, and Carta ID. The post conditions specify that the Admin can view the details of their created collectibles, including important information such as the description and the number of transfers and views. The success criteria are that the Admin can successfully view all relevant details of the collectibles they have created.

In another embodiment use case, the Super Admin includes a change password capability. This use employs the admin actor. The precondition for this feature is that the Super Admin is at the settings option. The flow begins with the Super Admin navigating to the settings page. The “Change Password” section displays three fields: “Current Password,” “New Password,” and “Confirm New Password.” The Super Admin first enters their current password in the “Current Password” field. Next, they enter their new password in the “New Password” field, ensuring it meets at least 8 characters, including a number and a special character. The Super Admin then re-enters their new password in the “Confirm New Password” field. Finally, the Super Admin clicks the “Save Changes” button. If the current password is correct and the new password and confirmation match, the system saves the new password and displays a success message. If the current password is incorrect or the new password and confirmation do not match, the system displays an error message. The post condition is that the Super Admin's password has been successfully changed. The success criteria are that the Super Admin is able to change their password successfully, and the system displays a success message confirming the change.

In another embodiment use case, the Super Admin includes a view and change settings capability. This use employs the admin actor. The preconditions for this feature include that the Admin is logged in to their account and that the website has a developed and deployed navigation menu that includes a settings option. The flow begins with the Admin selecting “Settings” from the navigation menu. The website then displays the settings screen, where the Admin can perform various actions such as changing their password, enabling or disabling 2FA for admin login, and stopping or enabling minting by confirming from the admin wallet address. The post conditions are that the Admin's changes are reflected on the website and saved to their account. The success criteria are that the Admin can easily modify their preferences using the available options or toggle switches, and these preferences are successfully reflected on the website and saved to their account.

In another embodiment use case, the Super Admin includes an invite user or partner capability. This use employs the admin actor. The precondition for this feature is that the Admin is logged in to their account. The flow begins with the Admin navigating to the “Manage Partners” section to invite a new partner. The Admin clicks the “Add Partner” button to initiate the invitation process for the partner. Similarly, the Admin navigates to the “Manage Users” section to invite a new user, where they click the “Add User” button. The Admin then enters the email address of the person they want to invite. The system sends an invitation link to the provided email address, along with a 7-digit code. The recipient receives the invitation link and clicks on it, leading them to the website where they can complete the onboarding process. The post conditions are that the new user or partner is added to the inviting Admin's network of connections on the app. An alternative flow for this process is that the Admin can also invite users by clicking on “Invite a User” from the bottom left navigation and selecting the role type, either partner or user. The success criteria are that the invitation link is sent successfully to the user, and the new user completes the sign-up process.

In another embodiment use case, the Partner use includes a landing page interface capability. This use employs the partner actor. The preconditions for accessing the site include that the user has entered the website's URL or clicked on a link leading to the website and has a device with internet access and a compatible web browser. The flow begins with the landing page loading and displaying the website's logo. Additionally, the landing page may feature a call-to-action button that offers options such as logging in with an email, recovering a forgotten password, or registering using a referral code. The post conditions indicate that the user has viewed the landing page and may have taken actions like logging in, recovering a password, or signing up using a referral code. The success criteria for the landing page are that it effectively encourages users to take actions, such as logging in, and that it is visually appealing and easy to navigate.

In another embodiment use case, the Partner use includes an onboarding with referral code capability. This use employs the partner actor. The preconditions for this process include the admin having created a new partner account in the system and having the partner's email address to send an invitation to join the platform. The flow begins with the partner receiving an email invitation to join the platform. The email contains a link, a 7-digit verification code, and a website link. The partner clicks on the link and is redirected to a page where they provide their email and the 7-digit verification code. The system verifies the code, and if it matches, the partner is redirected to a page where they can set their username and password. The partner enters their password, confirms it, and clicks on the “set password” button. Next, the partner is redirected to a page where they can set up their profile information, such as an image, username, and phone number, and then click on the “sign-up” button. Finally, the partner is redirected to the wallet connection popup. The post conditions are that the partner has successfully set up their account on the platform and can access and begin using its features and functionalities.

An alternative flow is provided if the partner enters incorrect information, they are prompted to correct the errors before submitting the form. If the partner enters a username that is already in use, the system prompts them to choose a different one. The success criteria include the partner receiving a confirmation email, successfully setting up an account using the email invitation link from the admin, and being able to log in to the platform using their email and password.

In another embodiment use case, the Partner use includes a connect with wallet capability. This use employs the partner actor. The sign-up process allows the user to connect newly created accounts with their wallet using Metamask. The preconditions for this process are that the web browser is integrated with the user's digital wallet provider, the user is on the website's landing page, and the user is not logged in. The flow begins with the user clicking on the “Connect with Metamask” button on the website. The user then selects their digital wallet and authenticates the connection between the website and the wallet. The website retrieves the user's public wallet address from the connected wallet and displays it to the user. The user confirms the public wallet address. After successfully creating the account, the user is redirected to the dashboard. The post conditions are that the user has successfully signed up for the app, and the user's digital wallet address has been verified and associated with their account.

An alternative flow is provided where the user can choose Metakeep if they do not have a Metamask wallet, the system will then create a wallet and associate it with the user's account. The success criteria are that the user can successfully create a new account on the website by connecting their digital wallet, the user's public wallet address is linked to their account, and the user can view and copy their wallet address from the dashboard.

In another embodiment use case, the Partner use includes a login with email and password capability. This use employs the partner actor. The “Login with email” feature allows users to securely and efficiently log in to the website using their email and password credentials. The preconditions for this feature are that the admin has created a new partner account in the system, the user has successfully completed the onboarding process by setting up their account, the user is on the website's landing page, and the user is not logged in. The flow begins with the user clicking on the “Login” button from the navigation menu. The user then enters their registered email address and password. The system verifies the entered email address and password. If the email address and password match the registered information, the user is directed to the “My Inventory” page. If the email address and password do not match the registered information, an error message is displayed stating “Invalid email or password!” The post condition is that the user is logged in to their account on the website.

An alternative flow is provided if the partner forgets their password, they can click on the “Forgot Password” button and reset their password using their registered email address. The success criteria are that the partner is able to successfully log in to their account using their registered email address and password.

In another embodiment use case, the Partner use includes a dashboard capability. This use employs the partner actor. The dashboard provides an overview of the user's activities, specifically designed for the Partner. The preconditions for accessing the dashboard are that the user is logged in and has an active account. The flow begins with the user logging in to their account on the website. Upon logging in, the user is initially redirected to the My Inventory page. From there, the user can navigate to the Dashboard. The dashboard displays various sections, including Collectibles stats, which show the Partner's NFTs that have been minted, transferred, are pending, or have been accepted. Additionally, the dashboard includes a listing of the most viewed collectibles. The post condition is that Partners can successfully view Collectible stats through the dashboard. The success criteria are that the dashboard is easy to navigate from the top header and provides relevant and comprehensive information to the partner.

In another embodiment use case, the Partner use includes a view navigation capability. This use employs the partner actor. The View Navigation feature enables users to access and navigate different sections of the website, providing an easy and intuitive navigation experience. The preconditions for using this feature are that the user is logged in to access the dashboard and has an active account. The flow begins with the user logging in to their account on the website. After logging in, the user selects the menu icon from the top of the screen. The website then displays the navigation menu, which includes various sections or features of the app. The user can select a section or feature from the navigation menu, and the app will display the selected section or feature. The navigation options include Dashboard, My Inventory, Create Collectible button, Inbox, Notifications icon, Dark Mode Icon, and Profile icon, with further options under the Profile icon such as QR Code, Setting, and Logout. The post conditions are that the user has successfully accessed and navigated to the selected section or feature, and the navigation menu is accessible and easy to use. The success criteria are that the user can quickly and easily navigate to different sections or features, and the navigation menu is clearly labeled and well-organized.

In another embodiment use case, the Partner use includes a my inventory interface capability. This use employs the partner actor. This feature enables the user, specifically the Partner, to view and manage their existing collectibles and listings on the website. The preconditions for this feature are that the Partner is logged in to their account and has created at least one collectible. The flow begins with the user navigating to the “My Inventory” page. Once on this page, the website displays a list of all the Partner's existing collectibles and listings. The user can select a specific collectible or listing to view its details. Additionally, the user has the option to search for a desired collectible. The post conditions indicate that the user can successfully view and manage their existing collectibles and listings.

An alternative flow is provided if the user has not created any collectibles or listings; in this case, the website displays a message informing them to create a new one. The success criteria are that the user can view a list of their existing collectibles and listings, can view details of any specific collectible or listing, and can successfully add a new collectible or listing.

In another embodiment use case, the Partner use includes a create collectible or digital asset capability. This use employs the partner actor. The create Collectible feature allows a partner to create a new Collectible item on the platform. This feature involves adding details such as the Collectible name, description, image, and other relevant information about the collectible. The preconditions for using this feature are that the Partner is logged in to their account and has access to the Create Collectible feature. The flow begins with the user clicking on the “Create Collectible” button or navigating to the “Create Collectible” page. The Partner is then prompted to enter the details of the Collectible, including an image, description, Collectible title, and Carta ID, which is the Tracking ID used to verify the NFT through a scan. Once the user selects a category, additional fields relevant to that category are displayed. For example, if the user selects the sports card category, the fields may include League, Authentication ID/name, Date of authentication, Certification ID, Date of creation, Signed by, Date signed, Grade/Condition, Player, Team, Card attributes, Series, Seasons, and Number. Fields for other categories can be specified and customized by the partner. The platform can accommodate the display of multiple images on the collectible detail page; however, only one of these images will be used as the actual NFT (Non-Fungible Token) representation. Once all the details are filled out, the Partner clicks on the “Create Collectible” button, and the Collectible is then shown on the collectible listing. The post conditions are that the Collectible is added to the My Inventory section. The success criteria are that the Partner is able to successfully create a Collectible with all required fields filled out, and the Collectible is successfully added to the Partner's collection.

In another embodiment use case, the Partner use includes a view my collectible details capability. This use employs the partner actor. The preconditions are that the user is logged in to their account and has created at least one collectible or listing. The flow begins with users logging into their account on the website. After logging in, the user navigates to the “My Inventory” section. From there, the user selects the specific collectible they want to view details of. The website then loads the details page for the selected collectible. The details displayed on this page include the collectible name, description, an image of the collectible, the owner and creator usernames, the date the collectible was created, the Carta ID, the number of times the collectible has been transferred, and the number of views it has received. Additionally, the partner has the option to make a collectible visible to users on the marketplace by enabling the ‘Visible’ toggle. By default, the collectible will not be visible on the marketplace unless this toggle is switched on. The partner can also send NFT transfer requests and manage ownership. The post conditions are that the user can view the details of their created collectibles, including important information like the description and the number of sales or views. The success criteria are that the user is able to successfully view the details of their created collectibles, including all relevant information.

In another embodiment use case, the Partner use includes a view my collectible details history capability. This use employs the partner actor. The preconditions are that the user is logged in to their account and has created at least one collectible or listing. The flow begins with the user logging into their account on the website. Once logged in, the user navigates to the “My Inventory” section. From this section, the user selects the specific collectible they want to view details of. The website then loads the details page for the selected collectible. At the bottom of the page, the collectible history is displayed, showing when the collectible was created (listed) and when it was transferred to another user. The post conditions are that the user can view the details of their created collectibles, including important information such as the description and the number of sales or views. The success criteria are that the user is able to successfully view the details of their created collectibles, including all relevant information.

In another embodiment use case, the Partner use includes an inbox and messaging capability. This use employs the partner actor. The Inbox feature enables users to view and manage their messages and notifications from other users, providing a convenient way for users to stay connected and up-to-date with their interactions. The preconditions are that the user is logged in to their account and that the website has been developed and deployed with a navigation menu that includes a messages option. The flow begins with the user selecting the menu icon from the top or side of the screen. The user then selects “Inbox” from the navigation menu. The system displays a list view of the user's messages and notifications. The user can select a message thread, and the system will display additional information about the selected message or notification, such as the message text and sender details. The user can take action on the message or notification, such as replying to a message. When a user sends a message to another user, the message will initially appear in the request section. The receiving user will then have the option to accept the request. Once the request is accepted, the message will be moved to the chat section, where both users can continue the conversation. The user also has the option to archive the message. Archived messages will be displayed in the archive section, allowing users to easily access them. Similar to the functionality in WhatsApp, users will have the option to unarchive the messages whenever they wish. By unarchiving the messages, users can bring them back to their regular message view and continue interacting with them as before. Additionally, the user can block messages from a specific user. After blocking the user's messages, the block button will be replaced with an unblock button, giving users the ability to easily unlock and restore the connection at any time. The post conditions are that the user has successfully accessed and viewed their Inbox. The user can view a list of their messages and notifications and take appropriate action on the message or notification if necessary. The post conditions are that the user has successfully accessed and viewed their Inbox. The user can view a list of their messages and notifications and take appropriate action on the message or notification if necessary.

An alternative flow is that if there are no messages or notifications for the user, the system will display a notification or message indicating that there is no activity to display. The success criteria are that the list view of messages and notifications is well-organized and visually appealing. The user can easily scroll through and select messages and notifications to view more details. The system provides relevant and accurate information about each message or notification, ensuring that users are well-informed. Additionally, the user can easily take action on the message or notification directly from the details view.

In another embodiment use case, the Partner use includes a view and update my profile capability. This use employs the partner actor. The “View My Profile” feature allows users to view their personal information, providing a convenient way for them to manage their account details. The preconditions for using this feature include that the user has logged in to their account. To use the feature, the user navigates to the “My Inventory” section of the website. Here, the website displays the user's profile information, which includes their profile picture, email address, username, and any other relevant details. The user can update their profile information, such as their image, username, and bio. Additionally, the user has the option to navigate to other sections of the app or log out of their account. The post conditions of this feature are that the user has successfully accessed and viewed their profile information, can view and edit their personal information, and has the ability to navigate to other sections of the website or log out of their account. If there is no profile image provided by the user, the system will display a default image. The success criteria for this feature are that the user can easily view and edit their personal information. Furthermore, the user can navigate to other sections of the app or log out of their account from the Profile section.

In another embodiment use case, the Partner use includes a view notifications capability. This use employs the partner actor. The “View Notifications” feature allows users to view any notifications that have been sent to their account, providing a convenient way for them to stay informed about updates, messages, and other important events related to their account and activities. The preconditions for this feature are that the user has logged in to their account. Additionally, the website has been developed and deployed with a navigation menu that includes a notifications option, and the system has a notification system capable of sending and receiving notifications. In the flow of using this feature, the user selects the menu icon from the bottom of the screen, which displays the navigation menu. The user then selects “Notifications” from this menu. The app displays a list of all notifications that have been sent to the user's account. Notifications can include approvals or rejections of collectible/ownership transfer requests. For example, if the user accepts a transfer request, they receive a notification stating, “[username] accepted your collectible request named “[collectible name]”. Check here for details,” which redirects to the collectible detail page. Similarly, if the user rejects a transfer request, the notification will state, “[username] rejected your collectible request named “[collectible name]”. Check here for details,” also redirecting to the collectible detail page. The post conditions are that the user has successfully accessed and viewed their notifications. If there are no notifications for the user, the system will display a notification or message indicating that there are no new notifications. The success criteria for this feature include the user's ability to easily view any relevant notifications. Additionally, the user is able to navigate to other sections of the app or log out of their account from the Notifications section.

In another embodiment use case, the User use includes a view and change settings capability. This use employs the user actor. The “View/Change Settings” feature allows users to view and modify their account settings. This feature enables partners to manage their wallet, in-app notifications, email notifications, and settings for messages and collectible requests, providing them with control over their account and privacy settings. The preconditions for this feature include that the user has logged in to their account. Additionally, the website has been developed and deployed with a navigation menu that includes a settings option. In the flow of using this feature, the user selects the menu icon from the side or top of the screen. This action displays the navigation menu, from which the user selects “Settings.” The website then displays the settings screen, where the user can change their password, message settings, and message request settings. The post conditions are that the user has successfully accessed and modified their account settings, including their password. The changes made by the user are reflected on the website and are saved to their account. The success criteria include the user's ability to easily modify their preferences using the available options or toggle switches. Additionally, the user's preferences are accurately reflected on the website and saved to their account.

In another embodiment use case, the Partner use includes an invite user capability. This use employs the partner actor. This feature allows existing partners to invite new users by sending them an invitation link via email. The preconditions for this process include that the user inviting another has an existing account on the website and be logged into their account. The preconditions for this process include the user inviting another having an existing account on the website and being logged into their account. The post conditions are that the new user has successfully signed up on the website.

In an alternative flow, if the recipient already has an account on the website, they will be notified with a message stating, “User already exists!” The success criteria for this process are that the referral code is sent successfully to the recipient, and the new user completes the sign-up process.

In another embodiment use case, the Partner use includes a transfer request from partner capability. This use employs the partner actor. The feature allows the Partner to send a collectible transfer request to a user to transfer ownership of a specific collectible. The preconditions for this process include that the user is logged into their account, and the Partner is the owner of the collectible. The flow begins with the Partner selecting the collectible they wish to transfer. The Partner then enters the Carta username of the user to whom they wish to send the transfer request. After entering the necessary details, the Partner clicks on the “Confirm” button and reviews the details of the transfer. The Partner then inputs a two-factor authentication (2FA) code from the Google Authenticator app, which the system validates. The user receives the transfer request on their mobile app, where they can accept or decline the request. If the user accepts the request and verifies it by scanning an RFID tag, the ownership of the collectible can be transferred to the user. The flow begins with the Partner selecting the collectible they wish to transfer. The Partner then enters the Carta username of the user to whom they wish to send the transfer request. After entering the necessary details, the Partner clicks on the “Confirm” button and reviews the details of the transfer. The Partner then inputs a two-factor authentication (2FA) code from the Google Authenticator app, which the system validates. The user receives the transfer request on their mobile app, where they can accept or decline the request. If the user accepts the request and verifies it by scanning an RFID tag, the ownership of the collectible can be transferred to the user. In the alternative flow, if the user declines the transfer request, the ownership of the collectible remains with the Partner. The success criteria for this feature are that the Partner can send a transfer request to the intended user, the user receives a notification of the transfer request on their mobile app, and the user can accept or decline the transfer request. If the user accepts and verifies the request, the ownership of the collectible is transferred to the user.

In another embodiment use case, the Partner use includes a transfer ownership from partner capability. This use employs the partner actor. The feature allows the Partner to transfer the ownership of a collectible to a user for a specific collectible. The preconditions for this process are that the user is logged into their account, the Partner is the owner of the collectible, and the user has accepted and verified the collectible request. The flow begins with the Partner selecting the collectible they wish to transfer. The Partner clicks on the transfer ownership button and inputs a two-factor authentication (2FA) code from the Google Authenticator app. The system validates the 2FA code. The Partner then clicks on the transfer ownership button, and the system redirects to a Metamask wallet or Metakeep popup for verification. Once verified, the ownership of the collectible is transferred to the user. The post conditions are that the ownership of the NFT is successfully transferred to the user. In the alternative flow, if the user does not have sufficient balance in the wallet, the system will decline the request. The success criteria for this feature are that the Partner is able to transfer ownership to the intended user, and the user receives the collectibles in their “My Inventory” section on the mobile app.

In another embodiment use case, the User use includes a view splash screen capability. This use employs the user actor. The Splash Screen is the initial screen displayed when the mobile app is launched. It features the name and logo of the app, providing a brief introduction to the application. The preconditions for this feature are that the user has downloaded and installed the mobile app on their device. The flow of events begins when the user launches the app. The Splash Screen appears, displaying the app's name and logo. The Splash Screen remains visible for 2 to 3 seconds before automatically disappearing. In the post conditions, the user is taken to the “connect wallet/signup” screen after clicking the “get started” button. If the user has already launched the app previously, they are redirected to the sign-in page instead. The success criteria for this feature are that the Splash Screen loads quickly and smoothly, clearly showing the logo and name of the app.

In another embodiment use case, the User use includes a referral based signup capability. This use employs the user actor. Users will receive a referral code via email, which they can use to gain access to the app. Upon entering the app, users will be prompted to set a password and set up their profile, including a username, profile image, and mobile number. The preconditions for this process are that users have access to a device with internet connectivity, have received a referral code via email, and have the mobile app installed on their device. The flow of the process begins with the users opening the mobile app on their device. They then click on the “Referral Code” button and enter the email and referral code they received via email. In the password setup step, upon entering a valid referral code, users are prompted to set a password. Users enter their desired password, which meets at least 8 characters, including a number and a special character. Users confirm the password by re-entering it. In the profile setup step, users are directed to the profile setup screen, where they enter their desired username. They have the option to upload a profile image from their device's gallery or take a new photo. Users also enter their mobile number for contact purposes and submit the information. For the final step, users connect their account with a wallet by inputting their private wallet key. In the post conditions, the user is logged into their account and can access their home and other pages within the app.

An alternative flow occurs if the user forgets their password, they can click on the “Forgot Password” button and reset their password using their registered email address. The success criteria for this process are that the user is able to successfully set up their account using their registered email address and referral code.

In another embodiment use case, the User use includes a login with email and password capability. This use employs the user actor. The “Login with email” feature allows users to log in to the mobile app using their email and password. This feature provides secure and efficient authentication for users. The preconditions for this process are that the user has signed up for the mobile app using their email and has a registered account with the application, knowing their email and password. The flow of the process begins with the user clicking on the “Login” button from the navigation menu. The user then enters their registered email address and password. The system verifies the entered email address and password. If the email address and password do not match the registered information, an error message is displayed, prompting the user to enter the correct information. If the email address and password match the registered information, the user is directed to the wallet screen. The user then enters their wallet's private key and verifies their identity with their digital wallet provider. The app retrieves the user's public wallet address and verifies it against the user's identity. If the wallet address matches the registered wallet provided during signup, the user is directed to the home screen. In the post conditions, the user is successfully logged into their account and can access the app.

An alternative flow occurs if the user forgets their password, they can click on the “Forgot Password” button and reset their password using their registered email address. The success criteria for this process are that the user is able to successfully log in to their account using their registered email address and password and access the app without any errors.

In another embodiment use case, the User use includes a view mobile navigation capability. This use employs the user actor. The Mobile Navigation feature allows users to access and navigate different sections of the mobile app. The preconditions for this feature are that the user has launched the mobile app and logged into their account. Additionally, the mobile app has been developed and deployed with a navigation menu. The flow begins with the app displaying the home screen. The user then selects the menu icon from the bottom of the screen, which brings up the navigation menu. This menu includes different sections or features of the app. The user can select a section or feature from the navigation menu, and the app will display the chosen section or feature. The navigation menu includes various options, such as: Bottom Menu Names: Home Page, Search, Chat, Profile (with subsections for My Inventory, Activity, and Request), Top Menu Names: Chat Icon, Notifications Icon, and Right Menu Names: 2-step verification (Setup Google Authenticator), Change Password, Wallet address (View connected wallet address), Invite user, Logout. In the post conditions, the user has successfully accessed and navigated to the selected section or feature of the app. The navigation menu is designed to be accessible and easy to use. The success criteria are that the user can quickly navigate to different sections or features of the app. The navigation menu is clearly labeled and organized, allowing the user to easily return to the home screen or previous section from the navigation menu.

In another embodiment use case, the User use includes an explore marketplace capability. This use employs the user actor. The Explore Marketplace feature on the home and search pages allows users to browse and view various digital assets and collectibles available for purchase on the app. This feature offers an easy and efficient way for users to discover and explore new digital assets. The preconditions for this feature are that the user has launched the mobile app and logged into their account. The flow begins with the user launching the mobile app and selecting “Home or Search” from the bottom navigation. The app then displays a list or grid view of viewable collectible assets, including relevant information such as the collectible's name, the partner's username, the category, and an image. The user can select a digital asset to view more information and details about it. The app provides additional information about the selected collectible asset, including an image, the owner's name, and the category. Users can also mark the collectible as a favorite, allowing them to easily access their favorite collectibles. This option may be placed at the top of the page or on the home page. In the post conditions, the user has successfully accessed and explored the home and search pages, viewed a list or grid of available digital assets, and selected and viewed more details about a specific digital asset. In the alternative flow, if there are no digital assets available for purchase, the app displays a user-friendly message stating, “No collectible available.” The success criteria are that the list or grid view of digital assets is well-organized and visually appealing. The user can easily scroll through and select digital assets to view more details, and the app provides relevant and accurate information about each digital asset.

In another embodiment use case, the User use includes a search marketplace capability. This use employs the user actor. The preconditions are that the user has a registered account on the mobile app and is logged in. The flow begins with the user opening the mobile app and navigating to the search feature from the bottom navigation. The user then types the name of the collectible in the search bar. The system displays the search results based on the query entered by the user. Users can tap on any collectible to view its details. In the post conditions, the app successfully displays the search results, and the user can read them. The success criteria are that the user can search for a collectible in the search bar, the system displays the relevant search results, and the user can access the collectible page as desired.

In another embodiment use case, the User use includes a view and update my profile capability. This use employs the user actor. This feature allows users to view their personal information and provides a convenient way for users to manage their account details. The preconditions for accessing this feature are that the user has launched the mobile app, logged in to their account, and the app has access to a database or inventory of the user's account details. The flow begins with the user selecting “Profile” from the navigation menu. The app then displays the user's profile information, including their username and profile picture. Users have the option to add or update their profile image if desired. Additionally, users can navigate to other sections such as My Inventory, Activity, and Requests. The post conditions are that the user has successfully accessed and viewed their profile information, and they can view and edit their personal information. In the alternative flow, if there is no profile information or settings for the user, the app displays a default image. The success criteria are that the user can easily view and edit their personal information.

In another embodiment use case, the User use includes a view my inventory capability. This use employs the user actor. The “My Inventory” feature allows users to view the Collectibles they have purchased on the app, providing a convenient way for them to keep track of their collections and manage their digital assets. The preconditions for accessing this feature are that the user has launched the mobile app, logged in to their account, and the app has access to a database or inventory of the user's owned digital assets. The flow begins with the user selecting their profile from the menu icon at the bottom of the screen. The user then navigates to “My Inventory.” The app displays a grid view of the user's purchased digital assets, including the digital asset name and image. The user can select a digital asset to view more details. The app then displays additional information about the selected digital asset, such as on-sale visibility status, description, and other information. The user can also take action on the digital asset, such as transferring it. The post conditions are that the user has successfully accessed and viewed their digital assets on the app, viewed a grid of their purchased digital assets, selected and viewed more details about a specific digital asset, and taken appropriate action on the digital asset, if necessary. The success criteria include that the grid view of digital assets is well-organized and visually appealing, the user can easily scroll through and select digital assets to view more details, the app provides relevant and accurate information about each digital asset, and the user can easily take action on the digital asset from the details view.

In another embodiment use case, the User use includes a receive and accept NFT request from owner of collectible capability. This use employs the user actor. The preconditions for this process are that the user is logged into their account and has received a transfer request from the Partner or owner. The flow begins with the user navigating to the “My collection” section. There, the user views the specific collectible for which they have received a transfer request. The user then reviews the details of the transfer request, including the sender's username or carta ID. The user can choose to approve or reject the transfer request. After approval, the user verifies the physical collectible by scanning an RFID tag. If the user approves and verifies the transfer request, then the owner can transfer the collectible ownership. The post conditions are that if the user approves the transfer request, the collectible will be added to the user's “My Inventory.” If the user rejects the transfer request, the collectible will remain in the Partner's ownership. The success criteria include that the user is able to view transfer requests in the Request section, approve or reject transfer requests, and the collectible's ownership is transferred to the user's collection upon approval.

In another embodiment use case, the User use includes an inbox and messaging capability. This use employes the user actor. The Mobile Inbox feature allows users to view and manage their messages and notifications from other users on the app. This feature provides a convenient way for users to stay connected and up-to-date with their interactions. The preconditions for using this feature include that the user has launched the mobile app and logged in to their account. The app also has access to a database or inventory of messages and notifications for the user. The flow begins with the user launching the mobile app, which displays the home screen. The user then selects the “Chat” icon from the top icon or bottom navigation. The app displays a list view of the user's messages, from which the user can select a message thread. Additional information about the selected message or notification, such as the message text and sender details, is displayed. The user can take actions on the message or notification, such as replying to a message. When a user sends a message to another user, the message initially appears in the request section. The receiving user then has the option to accept the request. Once the request is accepted, the message moves to the chat section, where both users can continue the conversation. The user can also archive messages, which are then displayed in the archive section, allowing for easy access. Archived messages can be unarchived, bringing them back to the regular message view for further interaction. Additionally, the user can block messages from specific users. After blocking, the block button is replaced with an unblock button, giving users the ability to easily restore the connection at any time. The post conditions are that the user has successfully accessed and viewed their Inbox on the app. They can view a list of their messages and notifications and take appropriate action if necessary.

In an alternative flow, if there are no messages or notifications for the user, the app displays a notification or message indicating that no messages were found. The success criteria for this feature include that the list view of messages and notifications is well-organized and visually appealing. The user can easily scroll through and select messages and notifications to view more details. The app provides relevant and accurate information about each message or notification, and the user can easily take action on the message from the details view.

In another embodiment use case, the User use includes a view notifications capability. This use employes the user actor. The View Notifications feature allows users to view any notifications that have been sent to their account through the app. The preconditions for using this feature are that the user has launched the mobile app and logged in to their account. The mobile app has been developed and deployed with a notification system that can send and receive notifications. Additionally, the app has access to a database or inventory of notifications that have been sent to the user's account. The flow begins with the user selecting the notification icon from the top of the screen. The app then displays a list of all the notifications that have been sent to the user's account. The user can click on a notification to view its details. The post conditions are that the user has successfully accessed and viewed their notifications on the app. In the alternative flow, if there are no notifications for the user, the app displays a message indicating that there are no new notifications. The success criteria are that the user can easily access and view any relevant notifications.

In another embodiment use case, the User use includes a change password capability. This use employes the user actor. The preconditions for changing the password are that the user has launched the mobile app and logged in to their account. The flow involves the user navigating to the menu. The “Change Password” section displays three fields: “Old Password,” “New Password,” and “Confirm Password.” The user enters their current password in the “Old Password” field, then enters their new password in the “New Password” field. The new password meets at least 8 characters, including a number and a special character. The user then re-enters their new password in the “Confirm Password” field and clicks the “Save Password” button. If the current password is correct and the new password and confirmation match, the system saves the new password and displays a success message. If the current password is incorrect or the new password and confirmation do not match, the system displays an error message. The post conditions are that the user's password has been successfully changed. The success criteria are that users are able to change their password successfully, and the system displays a success message.

In another embodiment use case, the Partner use includes an invite a user capability. This use employes the partner actor. The feature allows existing users to invite new users by sending them an invitation referral code via email. The feature allows existing users to invite new users by sending them an invitation referral code via email. The flow involves the user navigating to the “Invite” section from the menu. The user enters the email address of the person they want to invite. The system then sends a referral code to the entered email address. The recipient receives the email, which can be used to sign up on the website. The new user then completes the sign-up process. The post conditions are that the new user has successfully signed up on the app and is added to the inviting user's network of connections on the app. Additionally, the new user connects to their wallet.

In an alternative flow, if the user enters an invalid or incorrect email address, the system prompts the user to correct the input. If the recipient already has an account on the website, they will be notified that they cannot accept the invitation as they already have an account. The success criteria are that the invitation email is sent successfully to the recipient, and the new user completes the sign-up process and is redirected to the app.

In another embodiment use case, the User use includes a transfer request from user capability. This use employes the user actor. The feature allows the user to send a collectible transfer request to another user in order to transfer ownership of a specific collectible. The preconditions for this process are that the user is logged into their account and is the owner of the collectible. The flow involves the user (owner) selecting the collectible they wish to transfer. The user then enters the username of the person they wish to send the transfer request to and clicks on the “Send Transfer Request” button. The system sends a notification to the recipient, informing them of the transfer request. The recipient can accept or decline the request through the link provided in the email notification. If the recipient accepts the request, the ownership of the collectible can be transferred to them. The post conditions are that if the recipient accepts the transfer request, the ownership of the collectible is transferred to them. If the recipient declines the request, the ownership of the collectible remains with the original user. In the alternative flow, if the username entered by the user is not registered in the system, an error message is displayed, indicating that the request can only be sent to active users. The success criteria are that the user is able to send a transfer request to the intended recipient, the recipient receives a notification of the transfer request, and the recipient is able to accept or decline the transfer request. If the recipient accepts the request, the ownership of the collectible is transferred to them.

In another embodiment of a use case, the User use includes an NFT transfer from user capability. This use employes the user actor. The feature allows the owner to transfer collectible ownership to another user. The preconditions for this process are that the user is logged into their account, is the owner of the collectible, and has accepted and verified the collectible request. The flow begins with the user navigating to the “My Inventory” section. The user (owner) then selects the collectible they wish to transfer ownership of. The user clicks on the transfer ownership button and inputs the 2FA code from the Google Authenticator app. The system validates the 2FA code, and the transfer is further confirmed using a slider for 2FA confirmation. After these steps, the user clicks on the transfer ownership button again, and once verified, the ownership is transferred to the intended recipient. The post condition is that the ownership of the NFT is successfully transferred to the recipient user. In the alternative flow, if the user does not have sufficient balance in the wallet, the system will decline the transfer ownership request. The success criteria are that the user (owner) is able to send the ownership to the intended recipient, and the recipient successfully receives the collectibles in their “My Inventory” on the mobile app.

In exemplary embodiments, an exemplary computerized method includes (and/or a system is operable for) real-time wireless verification using the physical asset tag (e.g., RFID signal detection) before transfer of the digital NFT; storing/withholding the digital NFT in a transfer queue until the buyer confirms receipt of the physical asset through the real-time wireless verification; and requiring that the transfer of the digital NFT is contingent upon the real-time wireless verification of the physical asset.

In exemplary embodiments, a computerized method for non-fungible token authentication comprises: creating an asset non-fungible token (NFT) associated with a physical asset; storing, in a partner wallet, a link between the asset NFT and a tag attached to the physical asset, wherein the tag includes at least one of a radio-frequency identification (RFID) tag or a near-field communication tag; initiating a transfer of the asset NFT to a user; receiving confirmation of wireless communication between a mobile computing device of the user and the tag attached to the physical asset; and transferring the asset NFT into a user wallet in response to confirmation of wireless communication between a mobile computing device of the user and the tag attached to the physical asset.

In some exemplary embodiments, the computerized method further includes storing the asset NFT in a transfer queue; receiving confirmation of a real-time wireless communication between a mobile computing device of the buyer user and the RFID or NFC tag attached to the physical asset; and transferring the asset NFT into the buyer user wallet from the transfer queue in response to confirmation of receipt of the physical asset through real-time wireless communication between a mobile computing device of the buyer user and the RFID or NFC tag attached to the physical asset.

In exemplary embodiments, a system for non-fungible token authentication comprises a tag attachable to a physical asset. The tag includes at least one of a radio-frequency identification (RFID) tag or a near-field communication tag. The system also includes a memory configured to store computer-executable instructions and at least one processor configured to execute the computer-executable instructions to: create an asset non-fungible token (NFT) associated with a physical asset; store, in a first user wallet, a link between the asset NFT and a tag attached to the physical asset, wherein the tag includes at least one of a radio-frequency identification (RFID) tag or a near-field communication tag; initiate a transfer of the physical asset to a second user; receive confirmation of wireless communication between a mobile computing device of the second user and the tag attached to the physical asset; and transfer the asset NFT into a wallet of the second user in response to confirmation of wireless communication between a mobile computing device of the second user and the tag attached to the physical asset.

In some exemplary embodiments, the system is further configured to be operable for storing the asset NFT in a transfer queue; receiving confirmation of a real-time wireless communication between a mobile computing device of the buyer user and the RFID or NFC tag attached to the physical asset; and transferring the asset NFT into the buyer user wallet from the transfer queue in response to confirmation of receipt of the physical asset through real-time wireless communication between a mobile computing device of the buyer user and the RFID or NFC tag attached to the physical asset.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. In the written description and claims, one or more steps within a method may be executed in a different order (or concurrently) without altering the principles of the present disclosure. Similarly, one or more instructions stored in a non-transitory computer-readable medium may be executed in different order (or concurrently) without altering the principles of the present disclosure. Unless indicated otherwise, numbering or other labeling of instructions or method steps is done for convenient reference, not to indicate a fixed order.

Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules) are described using various terms, including “connected,” “engaged,” “interfaced,” and “coupled.” Unless explicitly described as being “direct,” when a relationship between first and second elements is described in the above disclosure, that relationship encompasses a direct relationship where no other intervening elements are present between the first and second elements, and also an indirect relationship where one or more intervening elements are present (either spatially or functionally) between the first and second elements.

The phrase “at least one of A, B, and C” should be construed to mean a logical (A OR B OR C), using a non-exclusive logical OR, and should not be construed to mean “at least one of A, at least one of B, and at least one of C.” The term “set” does not necessarily exclude the empty set. The term “non-empty set” may be used to indicate exclusion of the empty set. The term “subset” does not necessarily require a proper subset. In other words, a first subset of a first set may be coextensive with (equal to) the first set.

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include processor hardware (shared, dedicated, or group) that executes code and memory hardware (shared, dedicated, or group) that stores code executed by the processor hardware.

The module may include one or more interface circuits. In some examples, the interface circuit(s) may implement wired or wireless interfaces that connect to a local area network (LAN) or a wireless personal area network (WPAN). Examples of a LAN are Institute of Electrical and Electronics Engineers (IEEE) Standard 802.11-2016 (also known as the WIFI wireless networking standard) and IEEE Standard 802.3-2015 (also known as the ETHERNET wired networking standard). Examples of a WPAN are IEEE Standard 802.15.4 (including the ZIGBEE standard from the ZigBee Alliance) and, from the Bluetooth Special Interest Group (SIG), the BLUETOOTH wireless networking standard (including Core Specification versions 3.0, 4.0, 4.1, 4.2, 5.0, and 5.1 from the Bluetooth SIG).

The module may communicate with other modules using the interface circuit(s). Although the module may be depicted in the present disclosure as logically communicating directly with other modules, in various implementations the module may actually communicate via a communications system. The communications system includes physical and/or virtual networking equipment such as hubs, switches, routers, and gateways. In some implementations, the communications system connects to or traverses a wide area network (WAN) such as the Internet. For example, the communications system may include multiple LANs connected to each other over the Internet or point-to-point leased lines using technologies including Multiprotocol Label Switching (MPLS) and virtual private networks (VPNs).

In various implementations, the functionality of the module may be distributed among multiple modules that are connected via the communications system. For example, multiple modules may implement the same functionality distributed by a load balancing system. In a further example, the functionality of the module may be split between a server (also known as remote, or cloud) module and a client (or, user) module. For example, the client module may include a native or web application executing on a client device and in network communication with the server module.

The term code, as used above, may include software, firmware, and/or microcode, and may refer to programs, routines, functions, classes, data structures, and/or objects. Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above.

Shared memory hardware encompasses a single memory device that stores some or all code from multiple modules. Group memory hardware encompasses a memory device that, in combination with other memory devices, stores some or all code from one or more modules.

The term memory hardware is a subset of the term computer-readable medium. The term computer-readable medium, as used herein, does not encompass transitory electrical or electromagnetic signals propagating through a medium (such as on a carrier wave); the term computer-readable medium is therefore considered tangible and non-transitory. Non-limiting examples of a non-transitory computer-readable medium are nonvolatile memory devices (such as a flash memory device, an erasable programmable read-only memory device, or a mask read-only memory device), volatile memory devices (such as a static random access memory device or a dynamic random access memory device), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. Such apparatuses and methods may be described as computerized apparatuses and computerized methods. The functional blocks and flowchart elements described above serve as software specifications, which can be translated into the computer programs by the routine work of a skilled technician or programmer.

The computer programs include processor-executable instructions that are stored on at least one non-transitory computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, JavaScript®, HTML 5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is:

1. A computer-implemented method for non-fungible token authentication and/or assigning on-chain ownership of a non-fungible token NFT), the method comprising:
creating an asset NFT associated with the physical asset;
storing, in a partner wallet, a link between the asset NFT and a tag attached to the physical asset, the tag comprising RFID or NFC;
initiating a transfer of the asset NFT to a user;
storing the asset NFT in a transfer queue on at least one server after initiating the transfer;
receiving confirmation of wireless communication between a mobile computing device of the user and the tag attached to the physical asset; and
in response to the confirmation, transferring the asset NFT from the partner wallet to a user wallet.

2. The method of claim 1, wherein the wireless communication is NFC and the confirmation comprises NFC signal detection of the tag by the mobile computing device.

3. The method of claim 1, wherein the wireless communication is RFID and the confirmation comprises RFID signal detection of the tag by the mobile computing device.

4. The method of claim 1, wherein the asset NFT includes a built-in smart contract comprising a transfer fee.

5. The method of claim 1, wherein the partner wallet and the user wallet are blockchain wallets configured to store multiple non-fungible tokens.

6. The method of claim 1, further comprising storing on a blockchain, for the asset NFT, at least one of: title, sales history, chain of ownership, provenance, origination information, or authentication information of the physical asset.

7. The method of claim 1, further comprising listing the asset NFT in a digital marketplace to offer the physical asset for sale or for trade.

8. The method of claim 1, wherein:
the asset NFT includes a built-in smart contract comprising a transfer fee; and
the partner wallet and the user wallet are blockchain wallets configured to store multiple non-fungible tokens.

9. The method of claim 8, further comprising:
storing on a blockchain, for the asset NFT, at least one of: title, sales history, chain of ownership, provenance, origination information, or authentication information of the physical asset; and
listing the asset NFT in a digital marketplace to offer the physical asset for sale or for trade.

10. A system for non-fungible token authentication and/or for assigning on-chain ownership of an NFT that represents a physical asset, the system comprising:
a tag affixed to the physical asset, the tag including at least one of a radio-frequency identification (RFID) tag or a near-field communication (NFC) tag;
memory configured to store computer-executable instructions; and
at least one processor configured to execute the computer-executable instructions to:
create an asset non-fungible token (NFT) associated with the physical asset;
store, in a partner wallet, a link between the asset NFT and the tag;
initiate a transfer of the asset NFT to a user;
store the asset NFT in a transfer queue on at least one server after the transfer is initiated;
receive the confirmation of wireless communication between the mobile computing device of the user and the tag; and
transfer, in response to the confirmation, the asset NFT from the partner wallet to a wallet of the user.

11. The system of claim 10, wherein the tag is an NFC tag and the wallet application confirms NFC signal detection.

12. The system of claim 10, wherein the tag is an RFID tag and the wallet application confirms RFID signal detection.

13. The system of claim 10, wherein the asset NFT includes a built-in smart contract comprising a transfer fee.

14. The system of claim 10, wherein the partner wallet and the wallet of the user are blockchain wallets configured to store multiple NFTs.

15. The system of claim 10, wherein on-chain data for the asset NFT stores at least one of: title, sales history, chain of ownership, provenance, origination information, or authentication information of the physical asset.

16. The system of claim 10, wherein the at least one processor is configured to execute the computer-executable instructions to store or list the asset NFT in a digital marketplace to offer the physical asset for sale or trade.

17. The system of claim 10, wherein:
the asset NFT includes a built-in smart contract comprising a transfer fee;
the partner wallet and the wallet of the user are blockchain wallets configured to store multiple NFTs;
on-chain data for the asset NFT stores at least one of: title, sales history, chain of ownership, provenance, origination information, or authentication information of the physical asset; and
the at least one processor is configured to execute the computer-executable instructions to store or list the asset NFT in a digital marketplace to offer the physical asset for sale or trade.

18. A computerized method for non-fungible token authentication, the method comprising:
creating an asset non-fungible token (NFT) associated with a physical asset;
storing, in a partner wallet, a link between the asset NFT and a tag attached to the physical asset, wherein the tag includes at least one of a radio-frequency identification (RFID) tag or a near-field communication (NFC) tag;
initiating a transfer of the asset NFT to a user;
receiving confirmation of wireless communication between a mobile computing device of the user and the tag attached to the physical asset; and
transferring the asset NFT into a user wallet in response to confirmation of wireless communication between a mobile computing device of the user and the tag attached to the physical asset.

19. The computerized method of claim 18, wherein the method includes:
storing the asset NFT in a transfer queue;
receiving confirmation of a real-time wireless communication between the mobile computing device of the user and the RFID or NFC tag attached to the physical asset; and
transferring the asset NFT into the user wallet from the transfer queue in response to confirmation of receipt of the physical asset through real-time wireless communication between the mobile computing device of the user and the RFID or NFC tag attached to the physical asset.

20. The computerized method of claim 18, further comprising, subsequent to initiating the transfer of the asset NFT to the user, storing the asset NFT in a transfer queue on at least one server, until receiving confirmation of wireless communication between the mobile computing device of the user and the tag attached to the physical asset.
